(19) United States
(12) Patent Application Publication
(10) Pub. No.: US 2007/0031607 A1
(43) Pub. Date: Feb. 8, 2007

(54) Method and apparatus for coating medical implants

(76) Inventors: Alexander Dubson, Petach-Tikva (IL); Ori Katz-Oz, Reut (IL); Eli Bar, Moshav Megadim (IL)

Correspondence Address: Martin D. Moynihan;PRTSI, Inc., P.O. Box 16446, Arlington, VA, 22215, US

(21) Appl. No.: 11/398,573

(22) Filed: Apr. 6, 2006

Related U.S. Application Data
(63) Continuation-in-part of application No. PCT/IL04/00917, filed on Oct. 5, 2004.
(63) Continuation-in-part of application No. 10/433,621, filed on Jun. 18, 2003, now Pat. No. 7,112,293.
Application No. 10/433,621 is a continuation of application No. 09/982,017, filed on Oct. 19, 2001, now abandoned.
(63) Continuation-in-part of application No. 10/433,620, filed on Jun. 18, 2003.
Application No. 10/433,620 is a continuation of application No. 09/982,017, filed on Oct. 19, 2001, now abandoned.
(60) Provisional application No. 60/508,301, filed on Oct. 6, 2003.
(60) Provisional application No. 60/276,956, filed on Mar. 20, 2001.
(60) Provisional application No. 60/256,323, filed on Dec. 19, 2000.
(60) Provisional application No. 60/276,956, filed on Mar. 20, 2001.
(60) Provisional application No. 60/256,323, filed on Dec. 19, 2000.

(51) Int. Cl. B05D 1/04; B05B 5/025; H05C 1/00

(52) U.S. Cl. 427/458; 118/621

(57) ABSTRACT

A method of coating a non-rotary object with an electrospun coat, the method comprising, dispensing a charged liquefied polymer through at least one dispensing element within an electric field to thereby form a jet of polymer fibers, and moving the dispensing element relative to the object so as to coat the object with the electrospun coat.

This application is a continuation-in-part of PCT Patent Application No. PCT/IL2004/000917, filed on Oct. 5, 2004, which claims the benefit of U.S. Provisional Patent Application Ser. No. 60/508,301, filed on Oct. 6, 2003.

This application is also a continuation-in-part of pending U.S. patent application Ser. No. 10/433,621, filed on Jun. 18, 2003, which is a National Phase of PCT Patent Application No. PCT/IL01/01168, filed on Dec. 17, 2001, which is a continuation of U.S. patent application Ser. No. 09/982,017, filed on Oct. 19, 2001, now abandoned, which claims the benefit of U.S. Provisional Patent Application No. 60/276,956, filed on Mar. 20, 2001, and U.S. Provisional Patent Application Ser. No. 60/256,323, filed on Dec. 19, 2000.

This application is also a continuation-in-part of pending U.S. patent application Ser. No. 10/433,620, filed on Jun. 18, 2003, which is a National Phase of PCT Patent Application No. PCT/IL01/01171, filed on Dec. 17, 2001, which is a continuation of U.S. patent application Ser. No. 09/982,017, filed on Oct. 19, 2001, now abandoned, which claims the benefit of U.S. Provisional Patent Application Ser. No. 60/276,956, filed on Mar. 20, 2001, and U.S. Provisional Patent Application Ser. No. 60/256,323, filed on Dec. 19, 2000.

The contents of each of the above applications are hereby incorporated by reference as, for all purposes as if fully set forth herein.

### FIELD AND BACKGROUND OF THE INVENTION

The present invention relates to a method and apparatus for coating an object and, more particularly, to a method and apparatus for coating an object using electrospinning. The present invention is particularly useful for coating medical implants.

Production of fibrous products is described in the literature inter alia using the technique of electrospinning of liquefied polymer, so that products comprising polymer fibers are obtained. Electrospinning is a method for the manufacture of ultra-thin synthetic fibers, which reduces the number of technological operations and increases the stability of properties of the product being manufactured.

The process of electrospinning creates a fine stream or jet of liquid that upon proper evaporation of a solvent to solid transition state yields a nonwoven structure. The fine stream of liquid is produced by pulling a small amount of polymer solution through space by using electrical forces. More particularly, the electrospinning process involves the subjection of a liquefied substance, such as polymer, into an electric field, whereby the liquid is caused to produce fibers that are drawn by electric forces to an electrode, and are, in addition, subjected to a hardening procedure. In the case of liquid which is normally solid at room temperature, the hardening procedure may be mere cooling; other procedures such as chemical hardening (polymerization) or evaporation of solvent may also be employed. The produced fibers are collected on a suitably located precipitation device and subsequently stripped from it. The sedimentation device is typically shaped in accordance with the desired geometry of the final product, which may be for example tubular, flat or even an arbitrarily shaped product.

Examples of tubular fibrous product which can be manufactured via electrospinning are, vascular prosthesis, particularly a synthetic blood vessel, and tubes through which a wire or other device or structure may pass or lie. Tubular fibrous products may also be used as various kinds of artificial ducts, such as, for example, urinary, air or bile duct.

Electrospinning can also be used for coating various objects, such as stents and other medical implants. Stents are widely used to provide coronaries with radial support so as to prevent constriction thereof. Nevertheless, clinical data indicates that stents are usually unable to prevent late restenosis beginning at about three months following an angioplasty procedure. Known in the art are stents having a mechanical barrier thereacross, designed to prevent biological material from the lesion to move through the stent and into the lumen during placement of the stent.

Production of polymer fiber shells suitable for use as vascular grafts is particularly difficult, since such grafts must withstand high and pulsatile blood pressures while, at the same time, be elastic and biocompatible.

Vascular grafts known in the art typically have a microporous structure that in general allows tissue growth and cell endothelization, thus contributing to long term engraftment and patency of the graft.

In vascular grafts, tissue ingrowth and cell endothelization is typically enhanced with increased in grafts exhibiting increased porosity. However, increasing the porosity of vascular grafts leads to a considerable reduction of the mechanical and tensile strength of the graft, and as a consequence to a reduction in the functionality thereof.

Electrospinning has been used for generating various products for medical applications, e.g., wound dressings, prosthetic devices, and vascular grafts as well as for industrial use, e.g., electrolytic cell diaphragms, battery separators, and fuel cell components. It has already been proposed to produce by electrospinning products having the appearance of shells. For example, U.S. Pat. No. 4,323,525 discloses a method of preparing a tubular product by electrostatically spinning a fiber forming material and collecting the resulting spun fibers on a rotating mandrel. U.S. Pat. No. 4,552,707 discloses a varying rotation rate mandrel which controls the “anisotropy extent” of fiber orientation of the final product. Additional examples of tubular shaped products and a like are disclosed, e.g., in U.S. Pat. Nos. 4,043,331, 4,127,706, 4,143,196, 4,223,101, 4,230,650 and 4,345,414.

In electrospinning, an electric field with high filed lines, density (i.e., having large magnitude per unit volume) may results in a corona discharge near the precipitation device, and consequently prevent fibers from being collected by the precipitation device. The filed lines density of an electric field is determined inter alia by the geometry of the precipitation device; in particular, sharp edges on the precipitation device increase the effect of corona discharge.

In addition, due to the effect of electric dipole rotation-along the electric field maximal strength vector in the vicinity of the mandrel, products with at least a section with a small radius of curvature are coated coaxially by the fibers. Such structural fiber formation considerably reduces the radial tensile strength of a spun product, which, in the case of vascular grafts, is necessary for withstanding pressures generated by blood flow.

Various electrospinning based manufacturing methods for generating vascular grafts are known in the prior art, see, for example, U.S. Pat. Nos. 4,044,404, 4,323,525, 4,738,740, 4,743,252, and 5,575,818. However, such methods suffer froth the above inherent limitations which limit the use thereof when generating intricate profile fiber shells.

Hence, although electrospinning can be efficiently used for generating large diameter shells, the nature of the electrospinning process prevents efficient generation of products having an intricate profile and/or small diameter, such as vascular grafts. In particular, since porosity and radial strength are conflicting, prior art electrospinning methods cannot be effectively used for manufacturing vascular grafts having both characteristics.

When a stent is electrospinningly coated by a graft of a porous structure, the pores of the graft component are invaded by cellular tissues from the region of the artery surrounding the stent graft. Moreover, diversified polymers with various biochemical and physico-mechanical properties can be used in stent coating.

With respect to mechanical barriers, coated stents having a mechanical barrier can prevent excessive tissue growth from occluding the vessel. U.S. Pat. No. 5,916,264, the contents of which are hereby incorporated by reference, disclose a stent graft including a sheet of PTFE sandwiched between two metal stents. Although this device has been successful at sealing aneurysms and perforations, it is a bulky device with a significantly larger crossing profile and reduced flexibility compared to a state-of-the-art stent.

Examples of electrospinning methods in stent graft manufacturing are found in U.S. Pat. Nos. 5,639,278, 5,723,004, 5,948,01.8, 5,632,772, 5,855,598, International Patent Application No. WO249535 and Australian Patent No. AU2249402.

It is known that the electrospinning technique is rather sensitive to the changes in the electrophysical and rheological parameters of the solution being used in the coating process. In addition, incorporation of drugs into the polymer in a sufficient concentration so as to achieve a therapeutic effect typically reduces the efficiency of the electrospinning process and causes different defects of the coating. Still in addition, drug introduction into a polymer reduces the mechanical properties of the resulting coating. Although this drawback is somewhat negligible in relatively thick films, for submicron fibers this effect may be adverse.

It is desired that a stent coat will have good adhesion to the stent metal basis in body liquids, so as not too detached after or during implantation. Further, the elasticity and strength of the stent coat should be compatible with the enormous inflation of the stent metal upon opening (about 300-500%). Additionally, it is desired that the stent coat will promote better grafting, reduce restenosis risk and optimize medication discharge into implantation-adjacent tissues.

With respect to the above requirements, the properties of prior art stent coats are far less than satisfactory. For example, in electrospinning systems having elongated electrode system, the electric field becomes critically asymmetrical, and the fibers obtain preferential longitudinal orientation. Such coat structure is known to have high anisotropy of mechanical properties in which axial strength (along fiber orientation). is favored over radial strength. It is recognized that radial strength is a crucial parameter, in particular in stent coat which, as stated, has to comply with significant inflation of the stent metal. In addition, in prior art electrospinning systems electrostatic repulsion between fibers results in increased opening angle of the jet, an expanded sedimentation area and low rupture strength.

In percutaneous coronary intervention (PCI), including balloon angioplasty and stent deployment, there is a risk of vessel damage during stent implantation. When the stent is expanded radially in the defective site, the plaques on the wall of the artery cracks and sharp edges thereof cut the surrounding tissue. This causes internal bleeding and a possible local infection, which, if not adequately treated, may spread and adversely affect other parts of the body.

Local infections in the region of the defective site in an artery do not lend themselves to treatment by injecting an antibiotic into the blood stream of the patient, for such treatment is not usually effective against localized infections. A more common approach to this problem is to coat the wire mesh of the stent with a therapeutic agent which makes contact with the infected region. However, such one-shot treatment is not sufficient to diminish infections, and it is often necessary to administer antibiotic and/or other therapeutic agents for several hours or days, or even months.

The risk of vessel damage during stent implantation may be lowered through the use of a soft stent serving to improve the biological interface between the stent and the artery and thereby reduce the risk that the stent will inflict damage during implantation. Examples of polymeric stents or stent coatings with biocompatible fibers are found in, for example, U.S. Pat. Nos. 6,001,125, 5,376,117 and 5,628,788, all of which are hereby incorporated by reference.

U.S. Pat. No. 5,948,018 discloses a graft composed of an expensible stent component covered by an elastomeric polymeric graft component which, because of its stretchability, does not inhibit expansion of the stent. The graft component is fabricated by electrospinning to achieve porosity hence to facilitate normal cellular growth. However, U.S. Pat. No. 5,948,018 fails to address injuries inflicted by the stent in the course of its implantation on the delicate tissues of the artery. These injuries may result in a local infection at the site of the implantation, or lead to other disorders which, unless treated effectively, can cancel out the benefits of the implant.

Additional prior art of interest include: Murphy et al. “Percutaneous Polymeric Stents in Porcine Coronary Arteries”, Circulation 86: 1596-1604, 1992; Jeong et al. “Does Heparin Release Coating of the Wallstent limit Thrombosis and Platelet Deposition?”, Circulation 92: 173A, 1995; and Wiedermann S. C. “Intercoronary Irradiation Markedly Reduces Necintimal Proliferation after Balloon Angioplasty in Swine” Amer. Col. Cardiol. 25: 1451-1456, 1995.

Prior art technologies, however, suffer from poor radial strength or having unsuitable porosity for being implanted in the body. Additionally, prior art technologies fail to provide a method of coating a medical implant while being mounted on a delivery system, such as a catheter balloon.

There is thus a widely recognized need for, and it would be highly advantageous to have, a method and apparatus for coating medical implants devoid of the above limitations.

### SUMMARY OF THE INVENTION

According to one aspect of the present invention there is provided an apparatus for manufacturing polymer fiber shells from liquefied polymer, the apparatus comprising: (a) a precipitation electrode being for generating the polymer fiber shell thereupon; (b) a dispenser, being at a first potential relative to the precipitation electrode so as to generate an electric field between the precipitation electrode and the dispenser, the dispenser being for: (i) charging the liquefied polymer thereby providing a charged liquefied polymer; and (ii) dispensing the charged liquefied polymer in a direction of the precipitation electrode; and (c) a subsidiary electrode being at a second potential relative to the precipitation electrode, the subsidiary electrode being for modifying the electric field between the precipitation electrode and the dispenser.

According to another aspect of the present invention there is provided a method for forming a liquefied polymer into a non-woven polymer fiber shells, the method comprising: (a) charging the liquefied polymer thereby producing a charged liquefied polymer; (b) subjecting the charged liquefied polymer to a first electric field; (c) dispensing the charged liquefied polymer within the first electric field in a direction of a precipitation electrode, the precipitation electrode being designed and configured for generating the polymer fiber shell; (d) providing a second electric field being for modifying the first electric field; and (e) using the precipitation electrode to collect the charged liquefied polymer thereupon, thereby forming the non-woven polymer fiber shell.

According to further features in preferred embodiments of the invention described below, the first electric field is defined between the precipitation electrode and a dispensing electrode being at a first potential relative to the precipitation electrode.

According to still further features in the described preferred embodiments step (c) is effected by dispensing the charged liquefied polymer from the dispensing electrode.

According to still further features in the described preferred embodiments the second electric field is defined by a subsidiary electrode being at a second potential relative to the precipitation electrode.

According to still further features in the described preferred embodiments the subsidiary electrode serves for reducing non-uniformities in the first electric field

According to still further features in the described preferred embodiments the subsidiary electrode serves for controlling fiber orientation of the polymer fiber shell generated upon the precipitation electrode.

According to still further features in the described preferred embodiments the subsidiary electrode serves to minimize a volume charge generated between the dispenser and the precipitation electrode.

According to still further features in the described preferred embodiments the method further comprising moving the subsidiary electrode along the precipitation electrode during step (e).

According to still further features in the described preferred embodiments the method further comprising moving the dispensing electrode along the precipitation electrode during step (c).

According to still further features in the described preferred embodiments the method further comprising synchronizing the motion of the dispensing electrode and the subsidiary electrode along the precipitation electrode.

According to still further features in the described preferred embodiments the dispenser comprises a mechanism for forming a jet of the charged liquefied polymer.

According to still further features in the described preferred embodiments the apparatus further comprising a bath for holding the liquefied polymer.

According to still further features in the described preferred embodiments the mechanism for forming a jet of the charged liquefied polymer includes a dispensing electrode.

According to still further features in the described preferred embodiments the dispenser is operative to move along a length of the precipitation electrode.

According to still further features in the described preferred embodiments the precipitation electrode includes at least one rotating mandrel.

According to still further features in the described preferred embodiments the rotating mandrel is a cylindrical mandrel.

According to still further features in the described preferred embodiments the rotating mandrel is an intricate-profile mandrel.

According to still further features in the described-preferred embodiments the intricate-profile mandrel includes sharp structural elements.

According to still further features in the described preferred embodiments the cylindrical mandrel is of a diameter selected from a range of 0.1 to 20 millimeters.

According to still further features in the described preferred embodiments the precipitation electrode includes at least one structural element selected from the group consisting of a protrusion, an orifice, a groove, and a grind.

According to still further features in the described preferred embodiments the subsidiary electrode is of a shape selected from the group consisting of a plane, a cylinder, a torus and a wire.

According to still further features in the described preferred embodiments the subsidiary electrode is operative to move along a length of the precipitation electrode.

According to still further features in the described preferred embodiments the subsidiary electrode is tilted at angle with respect to a longitudinal axis of the precipitation electrode, the angle is ranging between 45 and 90 degrees.

According to still further features in the described preferred embodiments the subsidiary electrode is positioned at a distance of 5-70 millimeters from the precipitation electrode.

According to still further features in the described preferred embodiments the subsidiary electrode is positioned at a distance δ from the precipitation electrode, δ being equal to 12βR(1-V₂/V₁), where β is a constant ranging between about 0.7 and about 0.9, R is the curvature-radius of the polymer fiber shell formed on the precipitation electrode, V₁ is the first potential and V₂ is the second potential.

According to yet another aspect of the present invention there is provided an apparatus for manufacturing a polymer fiber shells from liquefied polymer, the apparatus comprising: (a) a dispenser, for: (i) charging the liquefied polymer thereby providing a charged liquefied polymer; and (ii) dispensing the charged liquefied polymer; and (b) a precipitation electrode being at a potential relative to the dispenser thereby generating an electric field between the precipitation electrode and the dispenser, the precipitation electrode being for collecting the charged liquefied polymer drawn by the electric field, to thereby form the polymer fiber shell thereupon, wherein the precipitation electrode is designed so as to reduce non-uniformities in the electric field.

According to still further features in the described preferred embodiments the precipitation electrode is formed from a combination of electroconductive and non-electroconductive materials.

According to still further features in the described preferred embodiments a surface of the precipitation electrode is formed by a predetermined pattern of the electroconductive and non-electroconductive materials.

According to still further features in the described preferred embodiments the precipitation electrode is formed from at least two layers.

According to still further features in the described preferred embodiments the at least two layers include an electroconductive layer and a partial electroconductive layer.

According to still further features in the described preferred embodiments the partial electroconductive layer is partial electroconductive layer is formed from a combination of an electroconductive material and at least one dielectric material.

According to still further features in the described preferred embodiments the dielectric material is selected from a group consisting of polyamide and polyacrylonitrile and polytetrafluoroethylene.

According to still further features in the described preferred embodiments the dielectric material is Titanium Nitride.

According to still further features in the described preferred embodiments the partial electroconductive layer, is selected of a thickness ranging between 0.1 to 90 microns.

According to one aspect of the present invention there is provided a method of coating a non-rotary object with an electrospun coat, the method comprising, dispensing a charged liquefied polymer through at least one dispensing element within an electric field to thereby form a jet of polymer fibers, and moving the dispensing element relative to the object so as to coat the object with the electrospun coat.

According to further features in preferred embodiments of the invention described below, the method further comprises translationally moving the object relative to the jet of the polymer fibers so as to uniformly distribute the polymer fibers onto the object.

According to still further features in the described preferred embodiments the translational motion is a harmonic motion.

According to still further features in the described preferred embodiments the translational motion is a reciprocation motion.

According to still further features in the described preferred embodiments the object is an expandable tubular supporting element.

According to still further features in the described preferred embodiments the expandable tubular-supporting element comprises a deformable mesh of metal wires.

According to still further features in the described preferred embodiments the expandable tubular supporting element comprises a deformable mesh of stainless steel wires.

According to still further features in the described preferred embodiments the object is a stent.

According to still further features in the described preferred embodiments the object is a stent assembly having at least one coat.

According to still further features in the described preferred embodiments the object is a stent mounted on a stent delivery system.

According to still further features in the described preferred embodiments the object is an implantable medical device.

According to still further features in the described preferred embodiments the object is an implantable medical device mounted on a stent delivery system.

According to still further features in the described preferred embodiments the method further comprises mounting the expandable tubular supporting element onto a mandrel, prior to the dispensation of the charged liquefied polymer.

According to still further features in the described preferred embodiments the method further comprises dispensing the charged liquefied polymer through the at least one dispensing element within the electric field, and moving the dispensing element relative to the mandrel so as to coat the mandrel, hence providing an inner coat to the expandable tubular supporting element.

According to still further features in the described preferred embodiments the method further comprises providing at least one adhesion layer onto the expandable tubular supporting element.

According to still further features in the described preferred embodiments the at least one adhesion layer is an impervious adhesion layer.

According to another aspect of the present invention there is provided an apparatus for coating a non-rotary object with an electrospun coat, the apparatus comprising at least one dispensing element being at a potential difference relative to the object, the at least one-dispensing element being capable of moving relative to the object while dispensing a charged liquefied polymer within an electric field defined by the potential difference, to thereby form a jet of polymer fibers coating the object.

According to further features in preferred embodiments of the invention described below, the at least one dispensing element is capable of moving along a circular path.

According to still further features in the described preferred embodiments the at least one dispensing element is capable of moving along a helix path.

According to still further features in the described preferred embodiments the at least one dispensing element is capable of moving along a zigzag path.

According to still further features in the described preferred embodiments the at least one dispensing element is designed and constructed such that the electric field moves synchronically with the motion of the at least one dispensing element.

According to still further features in the described preferred embodiments the motion of the at least one dispensing element is selected so as to establish a spiral motion of the jet of the polymer fibers about the object, the spiral motion being characterized by a gradually deceasing radius.

According to still further features in the described preferred embodiments the at least one dispensing element comprises an arrangement of electrodes.

According to still further features in the described preferred embodiments the at least one dispensing element comprises a rotatable ring having at least one capillary.

According to still further features in the described preferred embodiments the rotatable ring is made of a dielectric material.

According to still further features in the described preferred embodiments the rotatable ring is made of a conductive material.

According to still further features in the described preferred embodiments the apparatus further comprises a bath for holding a liquefied polymer, the bath being in fluid communication with the at least one dispensing element.

According to still further features in the described preferred embodiments the apparatus further comprises a pump for transferring the liquefied polymer from the bath to the at least one dispensing element.

According to still further features in the described preferred embodiments the apparatus further comprises a mechanism for translationally moving the object relative to the jet of the polymer fibers so as to uniformly distribute the polymer fibers onto the object.

According to still further features in the described preferred embodiments the apparatus further comprises the charged liquefied polymer and further wherein a medicament is mixed with the charged liquefied polymer and is co-dispensed therewith through the at least one dispensing element, so as to coat the object with an electrospun medicated coat.

According to still further features in the described preferred embodiments the apparatus further comprises a sprayer for distributing compact objects constituting a mendicant therein between the polymer fibers.

According to yet another aspect of the present invention there is provided a method of treating a constricted blood vessel, the method comprising: (a) providing a stent assembly; (b) dispensing a charged liquefied polymer through at least one dispensing element within an electric field to thereby form a jet of polymer fibers, and moving the dispensing element relative to the stent assembly so as to coat the stent assembly with an electrospun coat; and (c) placing the stent assembly in the constricted blood vessel.

According to further features in preferred embodiments of the invention described below, the method further comprises expanding the stent assembly so as to dilate tissues surrounding the stent assembly in a manner such that flow constriction is substantially eradicated.

According to still further features in the described preferred embodiments the motion of the at least one dispensing element is selected so as to establish a spiral motion of the jet of the polymer fibers about the stent assembly, the spiral motion being characterized by a gradually deceasing radius.

According to still further features in the described preferred embodiments the method further comprises translationally moving the stent assembly relative to the jet of the polymer fibers so as to uniformly distribute the polymer fibers onto the stent assembly.

According to still further features in the described preferred embodiments a medicament is mixed with the charged liquefied polymer and is co-dispensed therewith through the at least one dispensing element, so as to coat the object with an electrospun medicated coat.

According to still further features in the described preferred embodiments the medicament is dissolved in the charged liquefied polymer.

According to still further features in the described preferred embodiments the medicament is suspended in the charged liquefied polymer.

According to still further features in the described preferred embodiments the medicament is constituted by particles embedded in the polymer fibers.

According to still further features in the described preferred embodiments the method further comprises constituting a mendicant into compact objects and distributing the compact objects between the polymer fibers.

According to still further features in the described preferred embodiments the method further comprises providing at least one additional coat on the electrospun coat.

According to an additional aspect of the present invention there is provided a stent assembly comprising an expensible tubular supporting element and at least one coat of electrospun polymer fibers, each of the at least one coat having a predetermined porosity, the at least one coat including at least one pharmaceutical agent incorporated therein for delivery of the at least one pharmaceutical agent into a body vasculature during or after implantation of the stent assembly within the body vasculature.

According to an additional aspect of the present invention there is provided a method of producing a stent assembly, the-method comprising: (a) electrospinning a first liquefied polymer onto an expensible tubular supporting element, thereby coating the tubular supporting element with a first coat having a predetermined porosity; and (b)incorporating at least one pharmaceutical agent into the first coat.

According to yet another aspect of the present invention there is provided a method of treating a constricted blood vessel, the method comprising placing a stent assembly in the constricted blood vessel, the stent assembly comprises an expensible tubular supporting element and at least one coat of electrospun polymer fibers, each of the at least one coat having a predetermined porosity, the at least one coat including at least one pharmaceutical agent incorporated therein for delivery of the at least one pharmaceutical agent into a body vasculature during or after implantation of the stent assembly within the body vasculature.

According to still another aspect of the present invention there is provided a method of dilating a constricted blood vessel, the method comprising: (a) providing a stent assembly comprises an expensible tubular supporting element and at least one coat of electrospun polymer fibers, each of the at least one coat having a predetermined porosity, the at least one coat including at least one pharmaceutical agent incorporated therein; (b) placing the stent assembly to a constricted region in the constricted blood vessel; and (c) radially expanding the stent assembly within the blood vessel so as to dilate the constricted region and to allow blood flow through the blood vessel.

According to an additional aspect of the present invention there is provided a method of coating a medical implant, implantable in a body, the method comprising: (a) electrospinning a first liquefied polymer onto the medical implant, thereby coating the medical implant with a first coat having a predetermined porosity; and (b) incorporating at least one pharmaceutical agent into the first coat; thereby providing a coated medical implant.

According to further features in preferred embodiments of the invention described below, the at least one pharmaceutical agent is mixed with the liquefied polymer prior to the step of electrospinning, hence the step of incorporating the at least one pharmaceutical agent into the first coat is concomitant with the electrospinning

According to still further features in the described preferred embodiments the medical implant is selected from the group consisting of a graft, a patch and a valve.

According to still further features in the described preferred embodiments the at least one pharmaceutical agent is dissolved in the in the liquefied polymer.

According to still further features in the described preferred embodiments the at least one pharmaceutical agent is suspended in the liquefied polymer.

According to still further features in the described preferred embodiments the at least one pharmaceutical agent serves for treating at least one disorder in the blood vessel.

According to still further features in the described preferred embodiments the at least one disorder comprises an injury inflicted on tissues of the blood vessel upon implantation of the stent assembly therein.

According to still further features in the described preferred embodiments the at least one disorder is selected from the group consisting of restenosis and in stent stenosis.

According to still further features in the described preferred embodiments the at least one disorder is hyper cell proliferation.

According to still further features in the described preferred embodiments the at least one coat and the at least one pharmaceutical agent are configured and designed so as to provide a predetermined duration of the delivery.

According to still further features in the described preferred embodiments the delivery is by diffusion.

According to still further features in the described preferred embodiments the delivery is initiated by a radial stretch of the at least one coat, the radial stretch is caused by an expansion of the expensible tubular supporting element.

According to still further features in the described preferred embodiments the at least one coat comprises an inner coat and an outer coat.

According to still further features in the described preferred embodiments the inner coat comprises a layer lining an inner surface of the expensible tubular supporting element.

According to still further features in the described preferred embodiments the outer coat comprises a layer covering an outer surface of the expensible tubular supporting element.

According to still further features in the described preferred embodiments the at least one pharmaceutical agent is constituted by particles embedded in polymer fibers produced during the step of electrospinning.

According to still further features in the described preferred embodiments the step of incorporating at least one pharmaceutical agent into the first coat comprises constituting the at least one pharmaceutical agent into compact objects, and distributing the compact objects between polymer fibers produced during the step of electrospinning.

According to still further features in the described preferred embodiments the compact objects are capsules.

According to still further features in the described preferred embodiments the compact objects are in a powder form.

According to still further features in the described preferred embodiments the distributing of the compact objects is by spraying.

According to still further features in the described preferred embodiments the expensible tubular supporting element comprises a deformable mesh of stainless steel wires.

According to still further features in the described preferred embodiments the coat is of a tubular structure.

According to still further features in the described preferred embodiments the method further comprising mounting the tubular supporting element onto a rotating, mandrel.

According to still further features in the described preferred embodiments the method further comprising electrospinning a second liquefied, polymer onto the mandrel, hence providing an inner coat.

According to still further features in the described preferred embodiments the method further comprising electrospinning at least one additional liquefied polymer onto the first coat, hence providing at least one additional coat.

According to still further features in the described preferred embodiments the method further comprising providing at least one adhesion layer onto the tubular. supporting element.

According to still further features in the described preferred embodiments the method further comprising providing at least one adhesion layer onto at least one coat.

According to still further features in the described preferred embodiments the adhesion layer is an impervious adhesion layer.

According to still further features in the described preferred embodiments the providing at least one adhesion layer is by electrospinning.

According to still further features in the described preferred embodiments the electrospinning step comprises: (i) charging the liquefied polymer thereby producing a charged liquefied polymer; (ii) subjecting the charged liquefied polymer to a first electric field; and (iii) dispensing the charged liquefied polymers within the first electric field in a direction of the mandrel.

According to still further features in the described preferred embodiments the mandrel is of a conductive material.

According to still further features in the described preferred embodiments the first electric field is defined between the mandrel and a dispensing electrode being at a first potential relative to the mandrel.

According to still further features in the described preferred embodiments the method further comprising providing a second electric field defined by a subsidiary electrode being at a second potential relative to the mandrel, the second electric field being for modifying the first electric field.

According to still further features in the described preferred embodiments the subsidiary electrode serves for reducing non-uniformities in the first electric field.

According to still further features in the described preferred embodiments the subsidiary electrode serves for controlling fiber orientation of each of the coats.

According to still further features in the described preferred embodiments the mandrel is of a dielectric material.

According to still further features in the described preferred embodiments the tubular supporting element serves as a mandrel.

According to still further features in the described preferred embodiments the first electric field is defined between the tubular supporting element and a dispensing electrode being at a first potential relative to the tubular supporting element.

According to still further features in the described preferred embodiments the method further comprising providing a second electric field defined by a subsidiary electrode being at a second potential relative to the tubular supporting element the second electric field being for modifying the first electric field.

According to still further features in the described preferred embodiments the first liquefied polymer is a biocompatible liquefied polymer.

According to still further features in the described preferred embodiments the first liquefied polymer is a biodegradable liquefied polymer.

According to still further features in the described preferred embodiments the first liquefied polymer is a biostable liquefied polymer.

According to still further features in the described preferred embodiments first liquefied polymer is a combination of a biodegradable liquefied polymer and a biostable liquefied polymer.

According to still further features in the described preferred embodiments the second liquefied polymer is a biocompatible liquefied polymer.

According to still further features in the described preferred embodiments the second liquefied polymer is a biodegradable liquefied polymer.

According to still further features in the described preferred embodiments the second liquefied polymer is a biostable liquefied polymer.

According to still further features in the described preferred embodiments the second liquefied polymer is a combination of a biodegradable liquefied polymer and a biostable liquefied polymer.

According to still further features in the described preferred embodiments each of the at least one additional liquefied polymer is independently a biocompatible liquefied polymer.

According to still further features in the described preferred embodiments each of the at least one additional liquefied polymer is independently biodegradable liquefied polymer.

According to still further features in the described preferred embodiments each of the at least one additional liquefied polymer is independently a biostable liquefied polymer.

According to still further features in the, described preferred embodiments each of the at least one additional liquefied polymer is independently a combination of a biodegradable liquefied polymer and a biostable liquefied polymer.

According to still further features in the described preferred embodiments the at least one pharmaceutical agent is heparin.

According to still further features in the described preferred embodiments the at least one pharmaceutical agent is a radioactive compound.

According to still further features in the described preferred embodiments the at least one pharmaceutical agent is silver sulfadiazine.

According to still further features in the described preferred embodiments the method further comprising heating the mandrel prior to, during or subsequent to the step of electrospinning.

According to still further features in the described preferred embodiments the heating of the mandrel is selected from the group consisting of external heating and internal heating.

According to still further features in the described preferred embodiments the external heating is by at least one infrared radiator.

According to still further features in the described preferred embodiments the at least one infrared radiator is an infrared lamp.

According to still further features in the described preferred embodiments the internal heating is by a built-in heater.

According to still further features in the described preferred embodiments the built-in heater is an Ohmic built-in heater.

According to still further features in the described preferred embodiments the method further comprising removing the stent assembly from the mandrel.

According to still further features in the described preferred embodiments the method further comprising dipping the stent assembly in a vapor.

According to still further features in the described preferred embodiments fits the method further comprising heating the vapor.

According to still further features in the described preferred embodiments the vapor is a saturated a DMF vapor.

According to still further features in the described preferred embodiments the, method further comprising exposing the stent assembly to a partial vacuum processing.

The present invention successfully addresses the shortcomings of the presently, known configurations by providing a method and apparatus for coating a object with an electrospun coat

The present invention successfully addresses the shortcomings of the presently known configurations by providing an electrospinning apparatus and method capable of fabricating a non-woven polymer fiber shell which can be used in vascular grafts.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a prior art electrospinning apparatus;

FIG. 2 is a schematic illustration of an electrospinning apparatus which includes a subsidiary electrode according to the teachings of the present invention;

FIG. 3 is a schematic illustration of an electrospinning apparatus which includes a planar subsidiary electrode according to the teachings of the present invention;

FIG. 4 is a schematic illustration of an electrospinning apparatus which includes a cylindrical subsidiary electrode according to the teachings of the present invention;

FIG. 5 is a schematic illustration of an electrospinning apparatus which includes a linear subsidiary electrode according to the teachings of the present invention;

FIG. 6 is a schematic illustration of an electrospinning apparatus which includes a composite subsidiary electrode according to the teachings of the present invention;

FIG. 7a is a flowchart diagram of a method of coating a non-rotary object with an electrospun coat, according to a preferred embodiment of the present invention.

FIGS. 7b-e are schematic illustrations of paths along which a dispensing element can move, according to a preferred embodiment of the present invention;

FIG. 7f is a schematic illustration of a spiral trajectory of a polymer fiber, according to a preferred embodiment of the present invention;

FIG. 8 is a cross-sectional view of a stent assembly according to a preferred embodiment of the present invention;

FIG. 9a is an end view the stent assembly, according to a preferred embodiment of the present invention;

FIG. 9b is an end view of a stent assembly which further comprises at least-one adhesion layer, according to a preferred embodiment of the present invention;

FIG. 10 is a tubular supporting element which is designed and constructed for dilating a constricted blood vessel in a body vasculature, according to a preferred embodiment of the present invention;

FIG. 11 is a portion of the tubular supporting element of FIG. 10 comprising a deformable mesh of metal wires, according to a preferred embodiment of the present 0 invention;

FIG. 12 is a stent assembly, manufactured according to the teachings of the present invention, occupying a defective site in an artery;

FIG. 13 is a portion of a non-woven web of polymer fibers produced according to a preferred embodiment of the present invention;

FIG. 14 is a portion of a non-woven web of polymer fibers which comprises a pharmaceutical agent constituted by compact objects and distributed between the electrospun polymer fibers;

FIG. 15 is a schematic illustration of an apparatus for coating a non-rotary object with an electrospun coat, according to a preferred embodiment of the present invention;

FIG. 16 is a flowchart diagram of a method of treating a constricted blood vessel, according to a preferred embodiment of the present invention.

FIG. 17 is a is a typical, prior art, electrospinning apparatus;

FIG. 18 is an electrospinning apparatus further including a subsidiary electrode according to the present invention;

FIG. 19 is an electrospinning apparatus including an electrostatic sprayer, two baths and two pumps;

FIG. 20 is an electrospinning apparatus including a supply for holding pharmaceutical agent, an electrostatic sprayer and a conical deflector;

FIG. 21 is an electron microscope image of material spun using conventional electrospinning techniques;

FIG. 22 is an electron microscope image of material spun using an apparatus which incorporates a flat subsidiary electrode, positioned 20 millimetres from the mandrel, according to the teachings of the present invention;

FIG. 23 is an electron microscope image of material spun using an apparatus which incorporates a flat subsidiary electrode, positioned 9 millimetres from the mandrel, according to the teachings of the present invention; and

FIG. 24 is an electron microscope image of polar-oriented material spun using an apparatus which incorporates a linear subsidiary electrode according to the teachings of the present invention.

### DESCRIPTION OF THE PREFERRED EMBODIMENTS

The present invention is of a method and an apparatus for manufacturing a polymer fiber shell using electrospinning. Specifically, the present invention can be used to manufacture intricate-profile products and vascular grafts of small to large diameter via electrospinning.

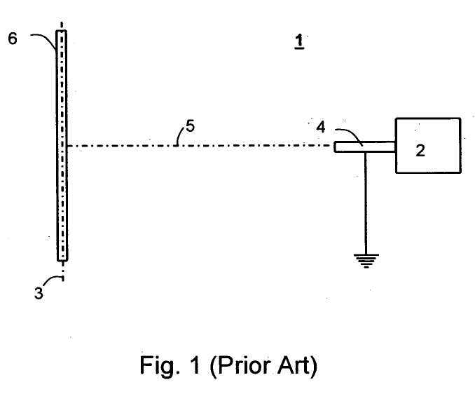

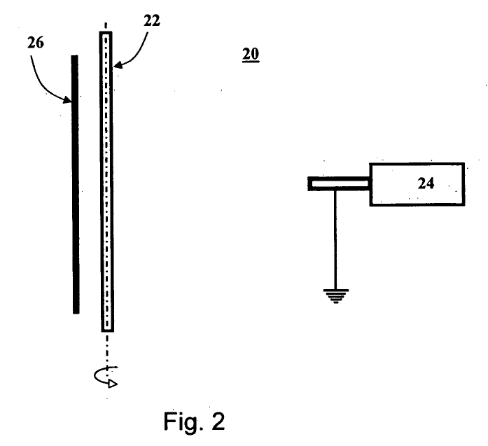

For purposes of better understanding the present invention, as illustrated in FIGS. 2-10 of the drawings, reference is first made to the construction and operation of a conventional (i.e., prior art) electrospinning apparatus as illustrated in FIG. 1.

Referring now to the drawings, FIG. 1 illustrates a conventional electrospinning apparatus for manufacturing a nonwoven material, generally referred to herein as apparatus 1.

Apparatus 1 includes a dispenser 2 which can be, for example, a bath provided with one or more capillary apertures 4. Dispenser 2 serves for storing the polymer to be spun in a liquid form (dissolved or melted). Dispenser 2 is positioned at a predetermined distance from a precipitation electrode 6, defining a first axis 5 therebetween. Precipitation electrode 6 serves for forming a structure thereupon. Precipitation electrode 6 is typically manufactured in accordance with the geometrical properties of the final product which is to be fabricated. For example, precipitation electrode 6 can be a mandrel having a longitudinal axis 3 which can be used for manufacturing tubular structures.

Dispenser 2 is typically grounded, while precipitation electrode 6 is connected to a source of high voltage (not shown in FIG. 1), preferably of negative polarity, thus forming an electric field between dispenser 2 and precipitation electrode 6. Alternatively, precipitation electrode 6 can be grounded while dispenser 2 is connected to a source of high voltage with positive polarity.

To generate a nonwoven material, the liquefied polymer is extruded, for example under the action of hydrostatic pressure, or using a pump (not shown in FIG. 1), through capillary apertures 4 of dispenser 2. As soon as meniscus of the extruded liquefied polymer forms, a process of solvent evaporation or cooling starts, which is accompanied by the creation of capsules with a semi-rigid envelope or crust.

An electric field, occasionally accompanied by a unipolar corona discharge in the area of dispenser 2, is generated by the potential difference between dispenser 2 and precipitation electrode 6. Because the liquefied polymer possesses a certain degree of electrical conductivity, the above-described capsules become charged. Electric forces of repulsion within the capsules lead to a drastic increase in hydrostatic pressure. The semi-rigid envelopes are stretched, and a number of point micro-ruptures are formed on the surface of each envelope leading to spraying of ultra-thin jets of liquefied polymer from dispenser 2.

Under the effect of a Coulomb force, the jets depart from dispenser 2 and travel towards the opposite polarity electrode, i.e., precipitation electrode 6. Moving with high velocity in the inter-electrode space, the jet cools or solvent therein evaporates, thus forming a jet of polymer fibers, collected on the surface of precipitation electrode 6, thus, forming a non-woven structure thereupon. Tubular non-woven structures are conventionally produced by rotating precipitation electrode 6 about longitudinal axis 3 during the electrospinning process, so as to circularly coat precipitation electrode 6.

Typical electrospinning processes (e.g., as employed by apparatus 1) suffer from several limitations.

First, as will be appreciated by a skilled artisan, when precipitation electrode 6 has a small radius of curvature, the polymer fibers tend to align axially along longitudinal axis 3. In such cases the resulting structure has an axial strength which is favored over the radial strength. Thus, small diameter products, have limited radial strength when manufactured via conventional electrospinning processes.

Second, conventional electrospinning processes for non-woven tubular structures are limited to the manufacturing of hollow tubes. This is done either by coating precipitation electrode 6 by the electrospun coat or by mounting a tubular member on precipitation electrode 6 prior to the initiation of the electrospinning process. In any event, the final product, once removed from precipitation electrode 6, is hollow. However, it is often desired to produce structures having additional members designed to engage the internal volume of the structure, it is recognized that with prior art electrospinning techniques, such additional internal members can only be inserted into the non-woven structure after the structure is removed from precipitation electrode 6. For example, with conventional electrospinning processes, it is not possible to coat a stent if it is already mounted on a stent delivery system.

Third, in a typical electrospinning process the electric field, generated between dispenser 2 and precipitation electrode 6, is static and the charged polymer fibers, which tend to align with the field lines, move along static trajectories. This limits the capability to control fiber orientation hence the strength of the final product.

Fourth, when using mandrels being at least partially with small radius of curvature, the orientation of the electric field maximal strength vector is such that precipitation electrode 6 is coated coaxially by the fibers. Thus, small diameter products, have limited radial strength when manufactured via existing electrospinning methods, as described above.

Fifth, when using mandrels with sharp edges and/or variously shaped and sized recesses, the electric field magnitude in the vicinity of precipitation electrode 6 may exceed the air electric strength (about 30 kV/cm), and a corona discharge may develop in the area of precipitation electrode 6. The effect of corona discharge decreases the coating efficiency of the process as described hereinbelow, and may even resultant in a total inability of fibers to be collected upon precipitation electrode 6.

Corona discharge initiation is accompanied by the generation of a considerable amount of air ions having opposite charge sign with respect to the charged fibers. Since an electric force is directed with respect to the polarity of charges on which it acts, theses ions start to move at the opposite direction to fibers motion i.e., from precipitation electrode 6 towards dispenser 2. Consequently, a portion of these ions generate a volume charge (ion cloud), non-uniformly distributed in the inter-electrode space, thereby causing electric field lines to partially close on the volume charge rather than on precipitation electrode 6. Moreover, the existence of an opposite- volume charge in the inter-electrode space, decreases the electric force on the fibers, thus resulting in a large amount of fibers accumulating in the inter-electrode space and gradually settling under gravity force. It will be appreciated that such an effect leads to a low-efficiency process of fiber coating.

Using an infinite-length/radius cylinder as a precipitation electrode 6 diminishes the effect described above. However, this effect is severe and limiting when small radii or complicated mandrels are employed for fabricating small radius or intricate-profile structures.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

While reducing the present invention to practice, it was uncovered that the use of a third electrode within an electrospinning apparatus enables to control the electric field generated between the dispenser and precipitation electrode. Specifically, a third electrode may either substantially decreases non-uniformities in the electric field or provides for controlled fiber orientation upon deposition.

Additionally, it has been realized by the present inventors that objects can be coated by allowing the dispensing element of the electrospinning apparatus to move along a predetermined path while keeping the objects in a non-rotary or static state. The advantage of the present embodiment in which the objects are non-rotary is that there is no need to mount the objects on a rotating electrode prior to the electrospinning process, thus allowing the coating of non-hollow as well as hollow objects. For example, the present embodiment can be used for providing an electrospun coat on stents or other medical implantable devices, either alone or while being mounted on a suitable delivery system, e.g., a stent delivery system, such as, but not limited to, a catheter balloon. This embodiment is useful when it is desired to improve strength, form a mechanical barrier and/or incorporate medicaments into commercially available medical implantable devices which are typically supplied by the vendor as “one unit products” in which the medical implantable devices are mounted on or integrated with additional members or devices.

Thus, according to a preferred embodiment of the present invention there is provided an apparatus for manufacturing a polymer fiber shell from a liquefied polymer, which apparatus is referred to herein as apparatus 20.

As shown in FIG. 2, apparatus 20 includes a precipitation electrode 22 which serves for generating the polymer fiber shell thereupon. Precipitation electrode 22 can be, for example, a mandrel of uniform or varying radius, which may include some structural elements such as, but not limited to, protrusions, orifices and grooves. The surface of precipitation electrode 22 may also contain grinds. The diameter of the mandrel may vary from about 0.1 millimeter up to about 20 millimeters depending on the diameter of the polymer fiber shell to be spun thereupon.

Apparatus 20 further includes a dispenser 24, which is at a first potential relative to precipitation electrode 22. Such a potential can be generated by grounding dispenser 24, and connecting a source of high voltage with negative polarity to precipitation electrode 22.

Alternatively, precipitation electrode 22 can be grounded while dispenser 24 is connected to a source of high voltage with positive polarity. In any case, an absolute value for the potential difference between dispenser 24 and precipitation electrode 22 may range between about 10 kV and about 100 kV.

The potential difference between dispenser 24 and precipitation electrode 22 ensures that an electric field is maintained therebetween, which electric field is important for the electrospinning process as described hereinabove.

Dispenser 24 serves for charging the liquefied polymer, thereby providing a charged liquefied polymer and dispensing the charged liquefied polymer in a direction of precipitation electrode 22. Dispenser 24 may also include a mechanism for moving it along a longitudinal axis of precipitation electrode 22, thus enabling dispensing of the charged liquefied polymer at various points along the longitudinal axis of precipitation electrode 22. The charged liquefied polymer may be, for example polyurethane, polyester, polyolefin, polymethyl methacrylate, polyvinyl aromatic, polyvinyl ester, polyamide, polyimide, polyether, polycarbonate, polyacrilonitrile, polyvinyl pyrrolidone, polyethylene oxide, poly (L-lactic acid), poly (lactide-CD-glycoside), polycaprolactone, polyphosphate ester, poly (glycolic acid), poly (DL-lactic acid), and some copolymers. Biolmolecules such as DNA, silk, chitozan and cellulose may also be used. Improved charging of the polymer may also be required. Improved charging is effected according to the present invention by mixing the liquefied polymer with a charge control agent (e.g., a dipolar additive) to form, for example, a polymer-dipolar additive complex which apparently better interacts with ionized air molecules formed under the influence of the electric field. It is assumed, in a non-limiting fashion, that the extra-charge attributed to the newly formed fibers is responsible for their more homogenous precipitation on the precipitation electrode, wherein a fiber is better attracted to a local maximum, which is a local position most under represented by older precipitated fibers, which keep their charge for 5-10 minutes. The charge control agent is typically added in the grams equivalent per liter range, say, in the range of from about 0.001 N to about 0.1 N, depending on the respective molecular weights of the polymer and the charge control agent used.

U.S. Pat. Nos. 5,726,107; 5,554,722; and 5,558,809 teach the use of charge control agents in combination with polycondensation processes in the production of electret fibers, which are fibers characterized in a permanent electric charge, using melt spinning and other processes devoid of the use of an precipitation electrode. A charge control agent is added in such a way that it is incorporated into the melted or partially melted fibers and remains incorporated therein to provide the fibers with electrostatic charge which is not dissipating for prolonged time periods, say months.

In a preferred embodiment of the present invention, the charge control agent transiently binds to the outer surface of the fibers and therefore the charge dissipates shortly thereafter (within minutes). This is because polycondensation is not exercised at all such the chemical intereaction between the agent and the polymer is absent, and further due to the low concentration of charge control agent employed. The resulting shell is therefore substantially charge free.

Suitable charge control agents include, but are not limited to, mono- and poly-cyclic radicals that can bind to the polymer molecule via, for example, —C=C—, =C-SH— or —CO-NH— groups, including biscationic amides, phenol and uryl sulfide derivatives, metal complex compounds, triphenylmethanes, dimethylmidazole and ethoxytrimethylsians. Typically, the charged liquefied polymer is dispensed as a liquid jet, moving at high velocity under electrical forces caused by the electric field. Thus, dispenser 24 typically includes a bath for holding the liquefied polymer and a mechanism for forming a jet, which mechanism may be, for example, a dispensing electrode.

Apparatus 20 further includes at least one subsidiary electrode 26 which is at a second potential relative to precipitation electrode 22. Subsidiary electrode 26 serves for controlling the direction and magnitude of the electric field between precipitations. electrode 22 and dispenser 24 and as such, subsidiary electrode 26 can be used to control the orientation of polymer fibers deposited on precipitation electrode 22. In some embodiments, subsidiary electrode 26 serves as a supplementary screening electrode. Broadly stated, use of screening results in decreasing the coating precipitation factor, which is particularly important upon mandrels having at least a section of small radii of curvature.

The size, shape, position and number of subsidiary electrode 26 is selected so as to maximize the coating precipitation factor, while minimizing the effect of corona discharge in the area of precipitation electrode 22 and/or so as to provide for controlled fiber orientation upon deposition.

According to one preferred embodiment of the present invention, subsidiary electrode 26 is positioned 5-70 mm away from precipitation electrode 22.

Preferably, such a distance is selected according to the following:
δ=12βR(1−V₂/V₁) (Eq. 1)
where β is a dimensionless constant named a fiber-charge accounting factor, which ranges between about 0.7 and about 0.9, R is the curvature-radius of precipitation electrode 22, V₁ is the potential difference between dispenser 24 and precipitation electrode 22 and V₂ is the potential difference between subsidiary electrode 26 and precipitation electrode 22.

Subsidiary electrode 26 may include a mechanism for moving it along a longitudinal axis of precipitation electrode 22. Such a mechanism may be in use when enhanced control over fiber orientation is required.

It will be appreciated that in an apparatus in which both dispenser 24 and subsidiary electrode 26 are capable of such longitudinal motion, such motion may be either independent or synchronized.

Subsidiary electrode 26 may also be tilted through an angle of 45-90 degrees with respect to the longitudinal axis of precipitation electrode 22. Such tilting nay be used to provide for controlled fiber orientation upon deposition, hence to control the radial strength of the manufactured shell; specifically, large angles result in higher radial strength.

In addition to positioning, the shape and size of electrode 26 may also determine the quality of the shell formed by apparatus 20. Thus, electrode 26 may be fabricated in a variety of shapes each serving a specific purpose. Electrode shapes which can be used with apparatus 20 of the present invention include, but are not limited to, a plane, a cylinder, a torus a rod, a knife, an arc or a ring.

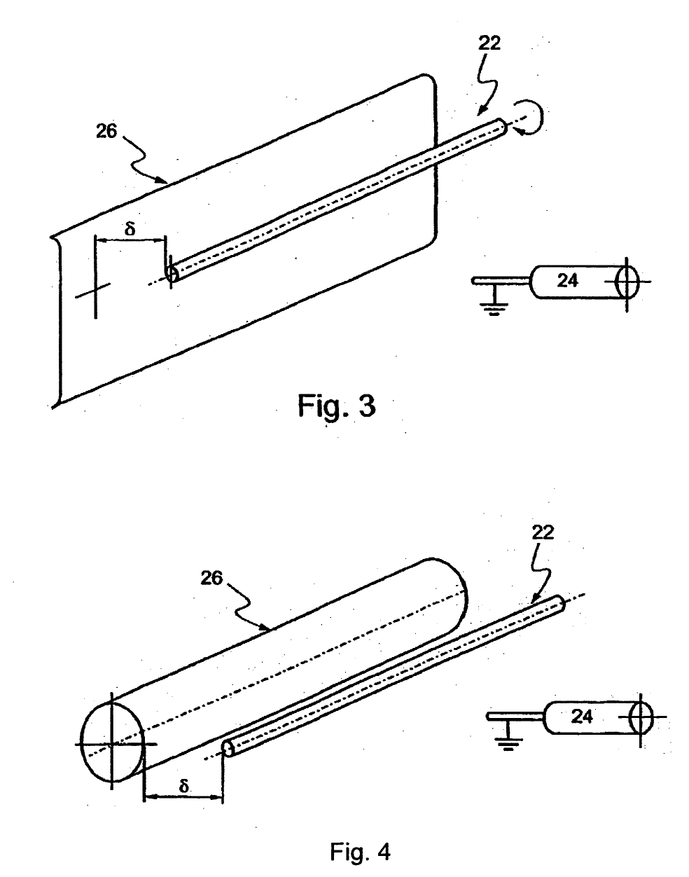

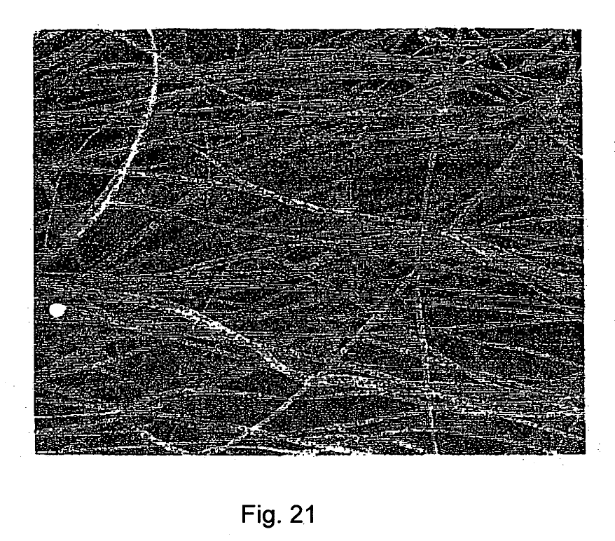

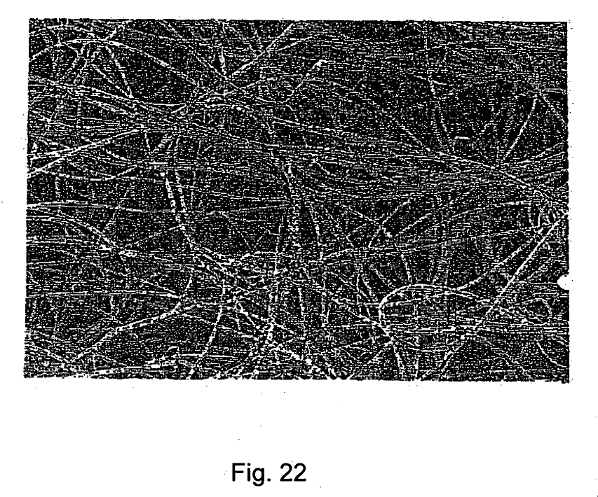

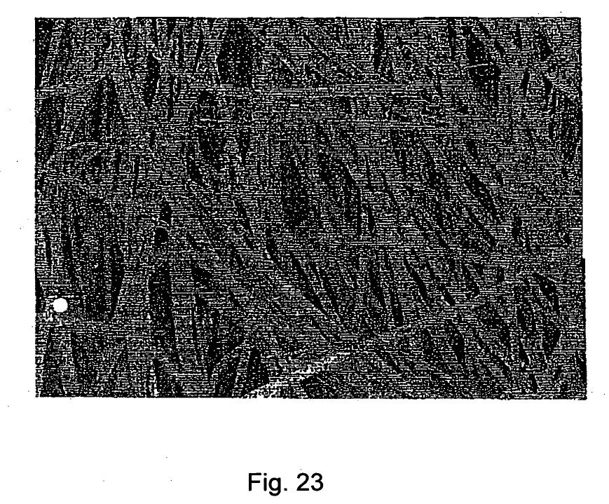

An apparatus 20 which includes a subsidiary electrode 26 of a cylindrical. (FIG. 4) or a flat shape (FIG. 3) enables manufacturing intricate-profile products being at least partially with small radius of curvature, which radius may range between 0.025 millimeters and 5 millimeters. As can be seen in FIGS. 22-23 (further described in the Examples section), the coating of such structures is characterized by random-oriented (FIG. 22) or even polar-oriented (FIG. 23) fibers, as opposed to an axial coating which is typical for small curvature products manufactured via existing electrospinning methods as demonstrated in FIG. 21 (further described in the Examples section).

Preferably, when a surface of large curvature is used as subsidiary electrode 26, as is the case above, the distance between subsidiary electrode 26 and precipitation electrode 22 can be determined as δ/x where x is a factor ranging between 1.8 and 2, and where δ is as defined by Equation 1 above.

Thus, positioning and/or shape of electrode 26 determines fiber orientation in the polymer fiber shell formed.

The ability to control fiber orientation is important when fabricating vascular grafts in which a high radial strength and elasticity is important. It will be appreciated that a polar oriented structure can generally be obtained also by wet spinning methods, however in wet spinning methods the fibers are thicker than those used by electrospinning by at least an order of magnitude.

Control over fiber orientation is also advantageous when fabricating composite polymer fiber shells which are manufactured by sequential deposition of several different fiber materials.

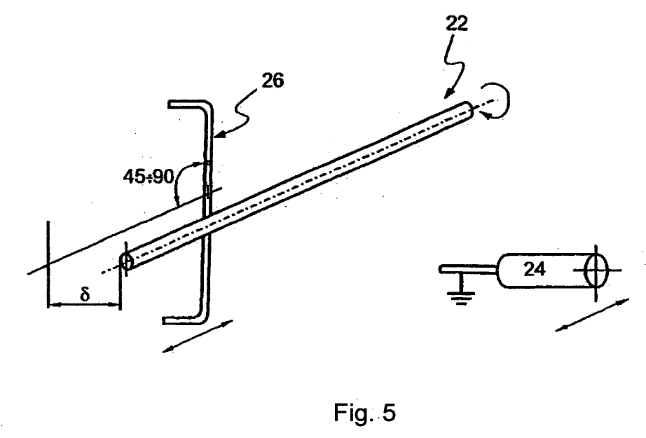

Reference is now made to FIG. 5, which illustrates an apparatus 20 which utilizes a linear (e.g., a rod, a knife, an arc or a ring) subsidiary electrode 26.

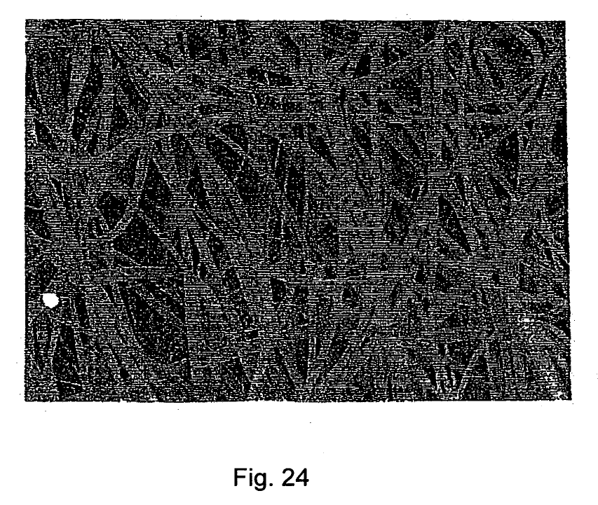

The effect of subsidiary electrode 26 of linear shape is based on the distortion it introduces to the electric field in an area adjacent to precipitation electrode 22. For maximum effect the diameter of subsidiary electrode 26 must be considerably smaller than that of precipitation electrode 22, yet large enough to avoid generation of a significant corona discharge. Fiber coating generated by apparatus 20 utilizing a linear subsidiary electrode 26 is illustrated by FIG. 24 which is further described in the Examples section hereinunder.

Thus, the present invention provides an electrospinning apparatus in which the electric field is under substantial control, thereby providing either random or predetermined fibers orientation.

Although the use of at least one subsidiary electrode is presently preferred, field non-uniformities can also be at least partially overcome by providing a composite precipitation electrode.

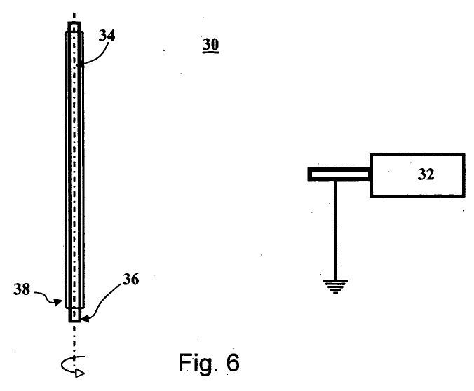

As illustrated in FIG. 6, precipitation electrode 34 of apparatus 30 having a dispenser 32 can be designed and configured so as to reduce non-uniformities in the electric field.

To overcome field non-uniformities, precipitation electrode 34 is fabricated from at least two layers of materials, an inner layer 36 made of electroconductive material and an outer layer 38 made of a material having high dielectric properties. Such a fabrication design results in a considerable increase of corona discharge threshold thus considerably reducing corona discharge from precipitation electrode 34.

Materials suitable for use with outer layer 38 of precipitation electrode 34, can be ceramic materials e.g., Titanium Nitride, Aluminum Oxide and the like, or polymer materials e.g., polyamide, polyacrylonitrile, polytetrafluoroethylene and the like. The thickness of outer layer 38 depends on the dielectric properties of the material from which it is made and can vary from less than one micron, in the case of, for example, a Titanium Nitride layer, or tens of microns, in the case of, for example, polytetrafluoroethylene, polyamide or polyacrylonitrile layer. In addition to diminishing corona discharge this precipitation electrode configuration enables easier separation of formed structures therefrom. Thus, according to this configuration outer layer 38 of precipitation electrode 34 can also be configured for facilitating the removal of the final product from the mandrel.

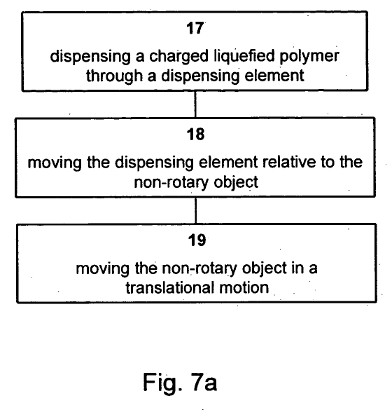

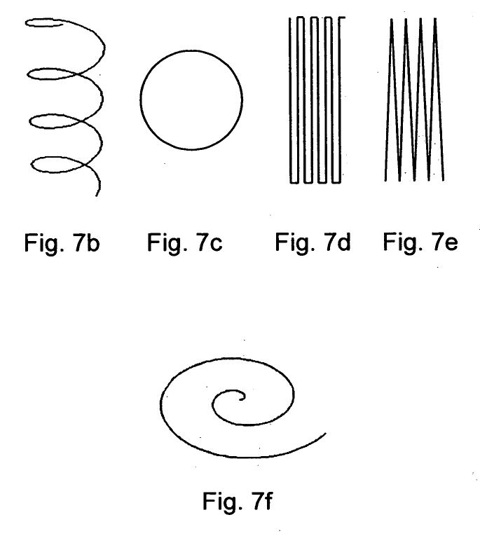

Reference is now made to FIG. 7a, which is a flowchart diagram of a method of coating a non-rotary object, according to a preferred embodiment of the present invention. In a first step on the method, designated in FIG. 7 by Block 107, a charged liquefied polymer is dispensed through at least one dispensing element within an electric field, to thereby form a jet of polymer fibers. In a second step of the, method, designated by Block 108, the dispensing element is moved relative to the object so as to coat the object with the electrospun coat. While moving along the predetermined path, the dispensing element(s) can change the direction and/or magnitude of the electric field. These changes can be tailored in accordance with the desired orientation of the polymer fibers on the object. As further detailed hereinabove.

As stated, the dispensing element can be moved along a predetermined path. The path is preferably selected so as to coat the entire object or selected portions thereof, as desired. For example, referring, to FIGS. 7b-d, when the object has a tubular shape (e.g., a cylinder) the dispenser can be moved along a helix path (FIG. 7b), a circular path (FIG. 7c), a zigzag path (FIG. 7d-e) and the like. The path and the parameters characterizing the path are preferably selected according to the desired orientation of fibers on the object. Several sweeps of the dispensing element along the objects can be employed so as to improve the homogeneity of the electrospun coat. The number of seeps is preferably selected according to the desired porosity of the coat, where larger number of sweeps corresponds to lower average pore size. Additionally, the density of the fibers and/or the type of liquefied polymer can be changes from one sweep to the other thereby to provide a multilayer coat, as further detailed hereinunder.

The motion of the dispensing element can be supplemented by a translational motion (e.g., reciprocation motion, harmonic motion, etc.) of the object relative to the jet of polymer fibers. This embodiment is particularly useful when the motion path of the dispensing element is planar (e.g., a circular path), such that upon reciprocal travel of the object relative to the motion plane of the dispensing element the fibers are re-distributed along the object and the homogeneity of the coat is improved.

According to the electrospinning principles, the electrical field is generated by a potential difference between the dispensing element and the object. Typical potential difference is from about 20 kV to about 50 kV. Such potential difference can be established, e.g., by grounding the dispensing element and placing the object in a negative potential or in any other electrostatic configuration which ensures the motion of the charged liquefied polymer from the dispensing element to the object. When the object comprises conductive parts (e.g., a metal mesh of a stent) the conductive parts can be connected to a voltage source, preferably of negative polarity. When the object is non conductive, or if desired, the object can be mounted on a precipitation electrode (e.g., a, mandrel), connected to a voltage source.

When the fibers moves in space they are subjected to friction forces which result from collisions between molecules of the medium surrounding the object (typically air) and molecules of the fibers. The higher the density of the surrounding medium the larger are the friction forces. According to a preferred embodiment of the present invention the velocity of the dispensing element is selected such that the polymer fibers acquire a sufficient transverse velocity relative to the axis defined by the dispensing element and the object (see, e.g., axis 5 in FIG. 1). A. typical linear velocity of the dispensing element is from about 100 cm/sec to about 3000 cm/sec. For a rotary motion of the dispensing element (e.g., helical, circular), a typical rotation frequency is from about 100 rpm to about 1200 rpm.

As used herein the term “about” refers to ±10%.

The trajectory of the polymer fibers in the medium surrounding the objects thus depends on (i) the electrical force applied by the electric field;. (ii) the friction force applied by molecules of the surrounding medium; and (iii) the transverse velocity of the fibers. As will be appreciated by one of ordinary skill in the art, when the electrospinning process is performed in a vacuum, there is no friction force and the trajectory of the polymer fibers depends only on the electric force and the transverse velocity. Thus, when the electrospinning process is performed in gaseous medium the trajectory of the polymer fiber is curvilinear, while for a process performed in a vacuum, due to the lack of friction, the trajectory is substantially rectilinear.

Beside the transverse velocity of the fibers, they also accelerate under the influence of the electric field in the direction of the electric field lines. Thus the direction of motion of the fibers at a given instant is the (vector) sum of the transverse velocity and the velocity acquired in the direction of the electric field. For example, when the dispensing element moves along a circular path, the jet of fibers moves along. a spiral motion, characterized by a gradually deceasing radius. A representative example of a spiral trajectory is shown in FIG. 7f.

It was found by the present inventors that although the polymer fibers have relatively low mass per unit length, the momentum acquired by the fibers due to tangent movement becomes sufficient to oppose the electrical field perturbing forces and to stabilize the movement of the fibers in space. For a tubular object and a circular motion of the dispensing element, it was found that at the aforementioned circular frequencies, the acquired momentum of the fibers is sufficient to provide a coat in which the fibers have a predominant azimuthal spatial orientation. In this respect, higher frequencies result in higher is azimuthal orientation extent. According to a preferred embodiment of the present invention the motion characteristics (eg., path, linear velocity, frequency) of the dispensing element are selected such that at least 60% of the polymer fibers, more preferably at least 80%, most preferably at least 90% has an azimuthal orientation with respected to the longitudinal axis of the object. Additionally or alternatively, the motion characteristics.(e.g., path, linear velocity, frequency) of the dispensing element are selected such that the electrospun coat is capable of bearing a radial expansion of at least 300%, more preferably at least 400%, most preferably at least 500% without being ruptured.

It was further found by the present inventors that the motion of the dispensing, element substantially narrows the jet spraying angle, thereby producing more concentrated jet resulting in a low average pore size of the final coat. The jet angle can further be narrowed by a judicious selection of the, geometrical shape of the dispensing element thereby the magnitude and direction of the electric field near the object and along the trajectory of the fibers. According to a preferred embodiment of the present invention the motion and/or shape of the dispensing element is selected, such that the spraying angle is narrowed by at least 10%, more preferably at least 30% and most preferably at least 60%. Thus, the combination of the electric force, friction force, transverse velocity and preferably the translational motion of the objects allows controlling the orientation, porosity as well as the density of the final coat.

For example, in applications in which the electrospun coat is applied on a stent, or other medical tubular implant, it is desired that the properties of the coat are suitable for implantation. Specifically, for high radial strength, a predominant azimuthal orientation of the fibers is preferred, which azimuthal orientation can be obtained, as stated, by selecting a circular motion for the dispensing element. Additionally, for blood vessel implants, such as stents and vascular prostheses, the porosity is selected so as to accommodate cells migrating from the surrounding tissues and to facilitate the proliferation of these cells while, at the same time, preventing undesired chemical materials and plaque debris from entering the blood vessel lumen during placement of the stent or prosthesis.

Furthermore, the controllable porosity of the present embodiment allows to design local drug delivery elements, whereby the coat may be incorporated with a mendicant or another pharmaceutical agent. In such devices, the porosity of the coat is preferably designed both to bear the independent drug load and to serve as a barrier controlling the drug release rate.

While the motion of the dispensing element has many advantages, as further, detailed above, a process in which the precipitation electrode rotates is not excluded from the scope of the present invention.

Thus, according to according to a preferred embodiment of the present invention there is provided a method of producing a stent assembly, the method comprising electrospinning a first liquefied polymer onto an expandable tubular supporting element, thereby coating the tubular supporting element with a first coat having a predetermined porosity; and incorporating at least one pharmaceutical agent into the first coat. In preferred embodiments, the pharmaceutical agent is mixed with the liquefied polymer prior to the electrospinning process. The step of incorporating the pharmaceutical agent into the first coat can therefore be concomitant with the step of electrospinning.

The method may further comprise providing a second electric field defined by a subsidiary electrode which is kept at a second potential difference relative to the supporting element (or the electrode which carries the supporting element). The purpose of the second electric field (and of the subsidiary electrode) is to modify the first electric field, so as to ensure a predetermined fiber orientation while forming the coat. Such predetermined orientation is particularly useful for providing a stent assembly having enhanced structural characteristics.

According to a preferred embodiment of the present invention the method further comprising providing an inner coat which lines the inner surface of the tubular supporting element. This embodiment is further detailed hereinunder.

The embodiments of the present invention can be used for coating expandable tubular supporting elements of stents, as well as stent assemblies which already have a preliminary coat. In any event, the above method can be used for providing single as well as multilayer coats, such as the coats disclosed in International Patent Application No. PCT/IL01/01171, the contents of which are hereby incorporated by reference.

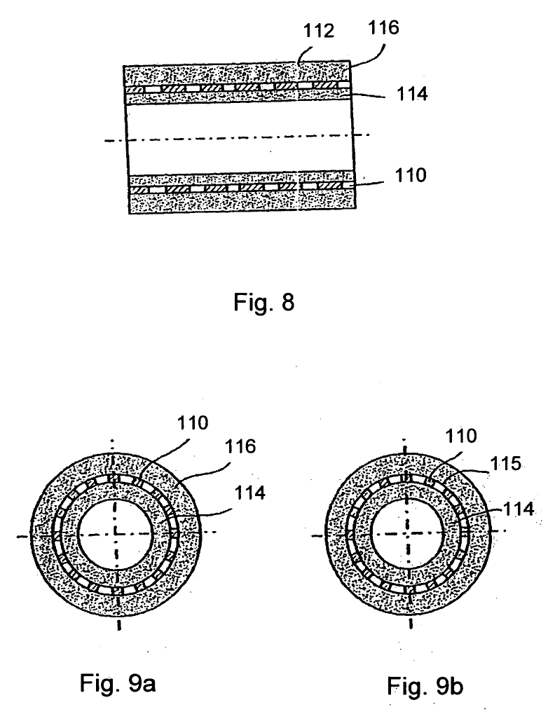

Reference is now to FIG. 8 which is a schematic illustration of a cross-sectional view of a stent assembly, according to various exemplary embodiments of the presents invention.

The stent assembly preferably comprises an expendable tubular supporting element 110 and at least one coat 112, having a predetermined porosity. Coat 112 comprises an inner coat 114, lining an inner surface of element 110 and an outer coat 116, covering an outer surface of element 110. FIG. 9a illustrates an end view of the stent assembly, showing element 110, internally covered by inner coat 114 and externally covered by outer coat 116. With reference to FIG. 9b, coat 112 may further comprise at least one adhesion layer 115, for adhering the components of the stent assembly as further detailed hereinafter.

According to a preferred embodiment of the present invention, at least one of the coats includes at least one pharmaceutical agent incorporated therein for delivery of the pharmaceutical agent into a body vasculature during or after implantation of the stent assembly within the body vasculature. The pharmaceutical agent serves for treating at least one disorder in a blood vessel.

Each of inner 114 and outer 116 coats can be provided using the abovemethod by moving the dispensing element relative to expandable supporting element 110 and/or rotating the expandable supporting element relative to the dispensing element. Preferably, inner 114 and outer 116 coats are made of different liquefied polymers and have predetermined porosities, which may be different or similar as desired. According to a preferred embodiment of the present invention, the liquefied polymer of inner 114 and/or outer 116 coats can be mixed with a mendicant or a pharmaceutical agent prior to the electrospinning process. The mendicant can be either dissolved or suspended in the liquefied polymer.

There is more than one way to provide outer coat 116. In one embodiment, element 110 is mounted on a precipitation electrode (e.g., a mandrel), prior to the electrospinning process. In this embodiment, the precipitation electrode function both as a carrier for element 110 and as a conductive element to which a high voltage is applied to establish the electric field. As a consequence, the polymer fibers emerging from the dispensing element are projected toward the precipitation electrode and form outer coat 116 on tubular supporting element 110. This coating covers both the metal wires of element 110 and gaps between the wires.

In another embodiment, element 110 serves as a precipitation electrode. In this embodiment, polymer fibers are exclusively attracted to the wires of tubular supporting element 110 exposing the gaps therebetween. The resultant coated stent therefore has pores which serve for facilitating pharmaceutical agent delivery from the stent assembly into body vasculature.

According to a preferred embodiment of the present invention inner coat 114 is provided as follows. First, the electrospinning process is employed so as to directly coat the mandrel, so as to form inner coat 114 thereon. Once the mandrel is coated, the electrospinning process is temporarily ceased and element 110 is slipped onto the mandrel and drawn over inner coat 114. Outer coat 116 is then provided by resuming the electrospinning process onto element 110.

Since the operation for providing inner coat 114 demands a process cessation for a certain period, a majority of solvent contained in inner coat 114 may be evaporated. This may lead to a poor adhesion between the components of the stent assembly, once the process is resumed, and might result in the coating stratification following stent graft opening.

The present invention successfully addresses the above-indicated limitation by two optimized techniques. According to one technique, the outer sublayer of inner coat 114 and the inner sub-layer of outer coat 116 are each made by electrospinning with upgraded capacity. A typical upgrading can may range from about 50% to about 100%. This procedure produce a dense adhesion layer made of thicker fibers with markedly increased solvent content. A typical thickness of the adhesion layer ranges between about 20 μm and about 30 μm, which is small compared to the overall diameter of the stent assembly hence does not produce considerable effect on the coats, general parameters. According to an alternative technique, the adhesion layer comprises an alternative polymer with lower molecular weight than the major polymer, possessing high elastic properties and reactivity.

Other techniques for improving adhesion between the layers and tubular supporting element 110 may also be employed. For example, implementation of various adhesives, primers, welding, chemical binding in the solvent fumes can be used. Examples for suitable materials are silanes such as aminoethyaminopropyl-triacytoxysilane and the like.

The advantage of using the electrospinning method for fabricating inner; coat 114 and outer coat 116 the is flexibility of choosing the polymer types and fibers thickness, thereby providing a final product having the required combination of strength, elastic and other properties as delineated herein. In addition, an alternating sequence of the sub-layers forming at coat 112, each made of differently oriented fibers, determines the porosity distribution nature along the stent assembly wall thickness. Still in addition, the electrospinning method has the advantage of allowing the incorporation of various chemical components, such as pharmaceutical agents, to be incorporated in the fibers by mixing the pharmaceutical agents in the liquefied polymers prior to electrospinning.

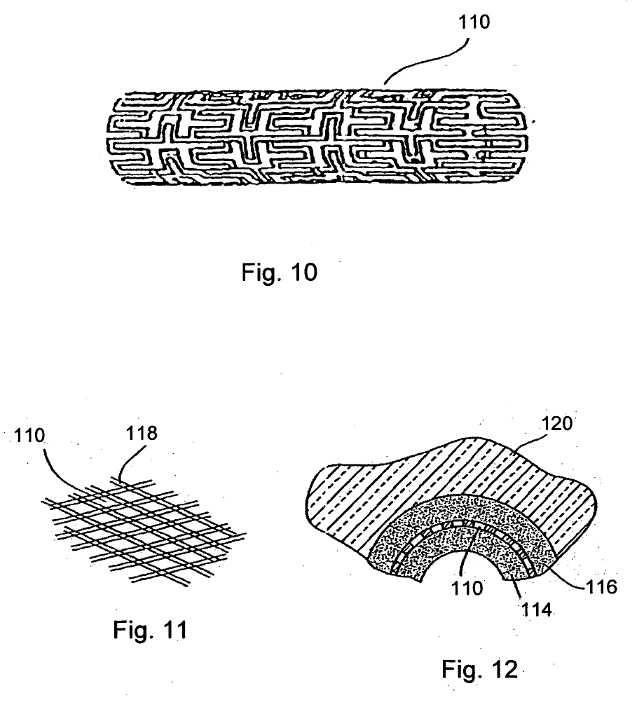

Reference is now made to FIG. 10 which is a schematic illustration of tubular supporting element 110 designed and constructed for dilating a constricted blood vessel in the body vasculature. Element 110 expands radially thereby dilates a constricted blood vessel. According to a preferred embodiment of the presents invention, the expansibility of the stent assembly may be optimized by a suitable construction of element 110 and coat 112. The construction of element 110 will be describe first with reference FIG. 11, and the construction of coat 112 will be described thereafter.

Hence, FIG. 11 illustrates a portion of element 110 comprising a deformable mesh of metal wires 113; which can be, for example, a deformable mesh of stainless steel wires. When the stent assembly is placed in the desired location in an artery, element 110 may be expanded radially, to substantially dilate the arterial tissues surrounding the stent assembly to eradicate a flow constriction in the artery The expansion may be performed by any method known in the art, for example by using a balloon catheter or by forming element 110 from a material exhibiting temperature-activated shape memory properties, such as Nitinol. According to a presently preferred embodiment of the invention, the polymer fibers forming coat 112 are elastomeric polymer fibers which stretch as element 110 is radially expanded. According to a preferred embodiment of the present invention inner coat 114 and outer coat 116 are coextensive with element 110, i.e., tubular supporting element 110 is substantially coated. Alternatively, inner coat 114 and/or outer coat 116 may be shorter in length than element 110, in which case at least one end of element 110 is exposed. Still in other embodiments of the invention, inner coat 114 may be absent.

Reference is now made to FIG. 12, which illustrates the stent assembly occupying a defective site 120 in an artery. The outer diameter of the stent assembly in its unexpanded state, including outer coat 116, is such that it ensures transporting of the stent assembly through the artery to defective site 120, for example by a catheter. The expending range of the stent assembly is such that when in place at defective site 120, the expanded assembly then has a maximum diameter causing the arterial tissues surrounding the stent assembly to be dilated to a degree eradicating the flow constriction at the site.

Implantation of the stent assembly in a blood vessel may result in disorders in the blood vessel, for example an injury inflicted on tissues of the blood vessel upon the implantation, restenosis, in-stent stenosis and hyper cell proliferation. To treat such injury or other disorders, coat 112 may comprise a medicament for delivery of the medicament into a body vasculature. Hence, coat 112 not only serves to graft the assembly to the artery but also functions as a reservoir for storing the medicament to be delivered over a prolonged time period. Within the above diameter limitation, the larger the aggregate volume of coat 112, the larger its capacity to store the medicament.

In addition, inner coat 114 and outer coat 116 are preferably porous so as to accommodate cells migrating froth the surrounding tissues and to facilitate the proliferation of these cells.

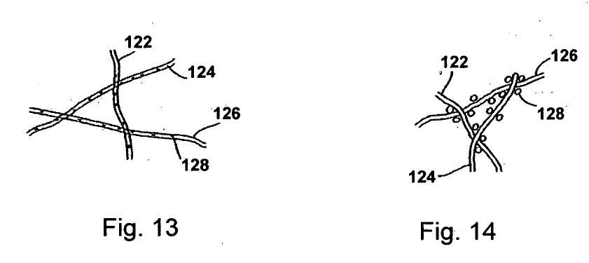

Reference is now made to FIG. 13 which illustrates a portion of a non-woven web of polymer fibers produced according to a preferred embodiment of the present invention. Fibers 122, 124 and 126 intersect and are joined together at the intersections, the resultant interstices rendering the web highly porous. Since electrospun fibers are ultra-thin, they have an exceptionally large surface area, which allows a high quantity of pharmaceutical agents and medicaments to be incorporated thereon. The surface area of the electrospun polymer fibers approaches that of activated carbon, thereby making the non-woven web of polymer fibers an efficient local drug delivery system.

The preferred mechanism of medicament release from the coat is by diffusion, regardless of the technique employed to embed the medicament therein. The duration) of therapeutic drug release in a predetermined concentration depends on several variants, which may be controlled during the manufacturing process. One variant is the chemical nature of the carrier polymer and the chemical means binding the medicament to it. This variant may be controlled by a suitable choice of the polymer(s) used in the electrospinning process. Another variant is the area of contact between the body and the medicament, which can be controlled by varying the free surface of the electrospun polymer fibers. Also affecting the duration of medicament release is the method used to incorporate the medicament within at least one coat 112, as is further described herein.

According to a preferred embodiment of the present invention, the coat comprises a number of sub-layers. Depending on their destination, the sub-layers can be differentiated by fiber orientation, polymer type, medicament incorporated therein and desired release rate thereof Thus, medicament release during the first hours and days following implantation may be achieved by incorporating a solid solution, containing a medicament such as anticoagulants and antithrombogenic gents, in a sub-layer of readily soluble biodegradable polymer fibers. During the first period following implantation the medicament that releases includes anticoagulants and antithrombogenic agents.

Referring now again to FIG. 13, the medicament may be constituted by particles 128 embedded in the electrospun polymer fibers forming a sub-layer of at least one coat 112. This method is useful for medicament release during the first post-operative days and weeks. To this end, the medicament can include antimicrobials or antibiotics, thrombolytics, vasodilators, and the like. The duration of the delivery process is effected by the type of polymer used for fabricating the corresponding sub-layer. Specifically, optimal release rate is ensured by using moderately stable biodegradable polymers.

Reference is now made to FIG. 14 illustrating an alternative method for incorporating the medicament in the coat, ensuring medicament release during the first. post-operative days and weeks. Thus, according to a preferred embodiment of the present invention, the medicament is constituted by compact objects 130 distributed between the electrospun polymer fibers of the coat. Compact objects 130 may be in any known form, such as, but not limited to, moderately stable biodegradable polymer capsules.

The present invention is also provides a method of releasing medicament, which may last from several months to several years. According to a preferred embodiment of the present invention the medicament is dissolved or encapsulated in a sub-layer made of biosatable fibers. The rate diffusion from within a biostable sub-layer is substantially slower, thereby ensuring a prolonged effect of medicament release. Medicaments suitable for such prolonged release include, without limitation, antiplatelets, growth-factor antagonists and free radical scavengers.

Thus, the sequence of medicament release and impact longevity of a certain specific medicaments is determined by the type of drug-incorporated polymer, the method in which the medicament is introduced into the electrospun polymer fibers, the sequence of layers forming the coat, the matrix morphological peculiarities of each layer and the concentration of the medicament.

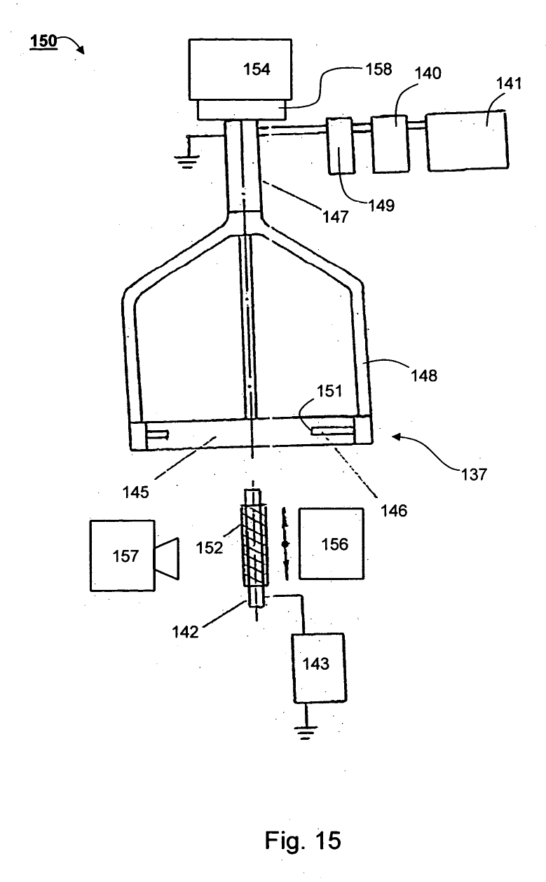

Reference is now made to FIG. 15, which is a schematic illustration of an apparatus 150 for coating a non-rotary object 152 with an electrospun coat, according to a preferred embodiment of the present invention. Apparatus 150 comprises at least one dispensing element 137 being at a potential difference relative to object 152, dispensing element 153 is capable of moving relative to object 152 while dispensing the charged liquefied polymer as further detailed hereinabove. Dispensing element 137 may be for example, an arrangement of electrodes or a rotatable ring 145 having at least one capillary 146, preferably radially oriented. Ring 145 can be made of a dielectric or conductive material as desired. Capillaries 146 are made of conductive, material and in electrical communication thereamongst. Preferably, the number of capillaries is from 1 capillary to more than 110 capillaries, more preferably 24 capillaries, most preferably 3 capillaries. The diameter of ring 145 and the length of capillaries 146 are preferably selected such that the distance between object 152 and tip 151 of capillary 146 is from about 100 mm to about 250 mm, more preferably from about 120 mm to about 180 mm, most preferably about 150 mm.

According to a preferred embodiment of the present invention dispensing element 137 is connected to a shaft 147 having at least one arm 148. Arms 148 and shaft 147 are preferably hollow elements to allow flow of the liquefied polymer therethrough. Alternatively a system of flexible tubes can be used to establish fluid communication between dispensing element 137 and a bath 141 which holds the liquefied polymer. Shaft 147 is preferably positioned between one or more bearings 158 and serves for mechanically connecting dispensing element 137 with an electric drive 154.

Apparatus 150 may further comprise a mandrel 142 which may be connected to a power supply 143 in embodiments in which mandrel 142 serves as conductive electrodes. Mandrel 142 or object 152 (in embodiments in which mandrel 142 is not used) is preferably operatively associated with a mechanism 156 for translationally moving object 152 as further detailed hereinabove.

According to a preferred embodiment of the present invention apparatus 150 further comprises a pump 140, connected to bath 141 for drawing the liquid polymer stored in bath 141 into dispensing element 137. Apparatus 150 may further comprise one or more filters 149, through which the liquefied is transferred via shaft 147 and arm 148 into element 137.

Optionally and preferably, apparatus 150 comprises a sprayer 157 for distributing compact objects (e.g., objects 130). constituting a mendicant therein between the polymer fibers, as further detailed hereinabove.

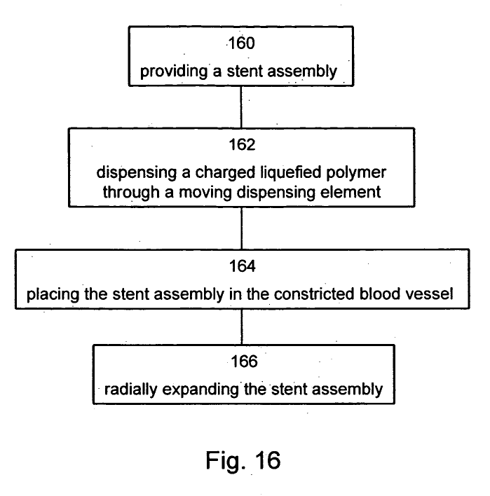

Reference is now made to FIG. 16, which is a flowchart diagram of a method of treating a constricted blood vessel, according to a preferred embodiment of the present invention. In a first step a first step on the method, designated in FIG. 16 by Block 160, a stent assembly is provided. In a second step, designated by Block 162, a charged liquefied polymer is dispensed through a moving dispensing element as further detailed hereinabove. In a third step of the method, designated by Block 164, the stent assembly is placed in the constricted blood vessel, for example, using a catheter balloon or other stent delivery system. In a forth step of the method, designated by Block 166, the stent assembly is preferably expanded so as to dilate the arterial tissues surrounding the stent assembly to a degree eradicating the flow constriction of the blood vessel.

It should be understood, that although the invention has been described in conjunction with medical implants, other medical implants, not necessarily of tubular structure, may be coated using the techniques of the present invention. For example, grafts and patches, which may be coated prior to procedure of implantation or application can be drug-loaded and enjoy the advantages as described herein.

The coat may be made from any known biocompatible polymer. In the layers which incorporate medicament, the polymer fibers are preferably a combination of a biodegradable polymer and a biostable polymer.

Representative examples of biostable polymers with a relatively low chronic tissue response include, without limitation, polycarbonate based aliphatic polyurethanes, siloxane based aromatic polyurethanes, polydimethylsiloxane and other silicone rubbers, polyester, polyolefins, polymethyl- methacrylate, vinyl halide polymer and copolymers, polyvinyl aromatics, polyvinyl esters, polyamides, polyimides, polyethers and many others that can be dissolved in appropriate solvents and electrically spun on the stent.

Biodegradable fiber-forming polymers that can be used include poly (L-lactic acid), poly (lactide-co-glycolide), polycaprolactone, polyphosphate ester, poly (hydroxy- butyrate), poly (glycolic acid), poly (DL-lactic acid), poly (amino acid), cyanocrylate, some co polymers and biomolecules such as DNA, silk, chitozan and cellulose.

These hydrophilic and hydrophobic polymers which are readily degraded by microorganisms and enzymes are suitable for encapsulating material for drugs. In particular, Polycaprolacton has a slower degradation rate than most other polymers and is therefore especially suitable for controlled-release of medicament over long periods of time scale ranging from about 2 years to about 3 years.

Suitable pharmaceutical agents that can be incorporated in at least one coat 112 include heparin, tridodecylmethylanumonium-heparin, epothilone A, epothilone B, rotomycine, ticlopidine, dekamethasone, caumadin, and other pharmaceuticals falling generally into the categories of antithrombotic drugs, estrogens, corticosteroids, cytostatics, anticoagulant drugs, vasodilators, and antiplatelet. drugs, trombolytics, antimicrobials or antibiotics, antimitotics, antiproliferatives, antisecretory agents, non-sterodial antiflammentory drugs, grow factor antagonists, free radical scavengers, antioxidants, radiopaque agents, immunosuppressive agents and radio-labeled agents.

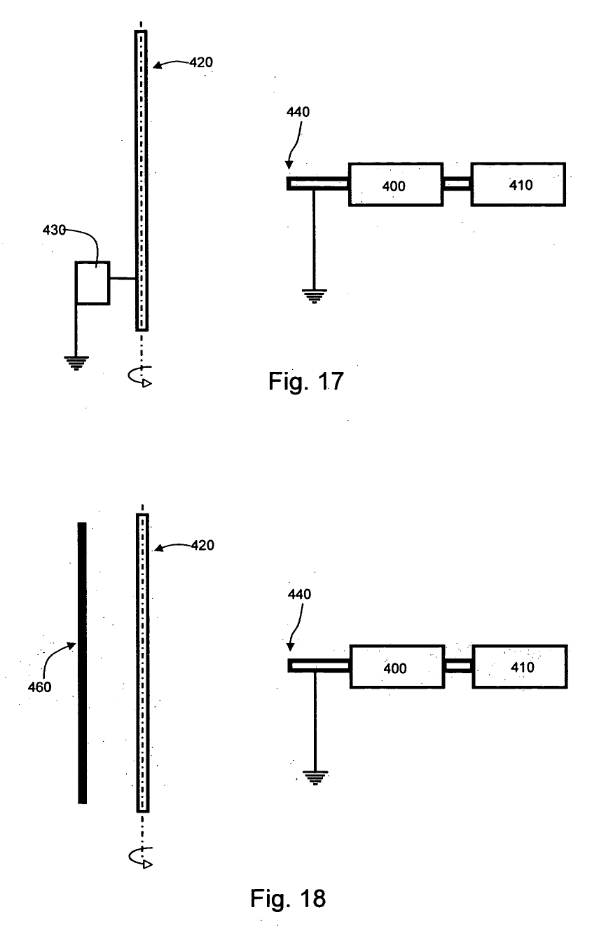

Reference is now made to FIG. 17 which is a schematic illustration of a typical electrospinning apparatus, which includes a pump 400, a mandrel 420 connected to a power supply 430 and a dispensing electrode 440. Pump 400 is connected to a bath 410 and serves for drawing the liquid polymer stored in bath 410 through a syringe (not shown in FIG. 17) into dispensing electrode 440. Mandrel 420 and dispensing electrode 440 are held under a first potential differences hence generating a first electric field therebetween. According to the electrospinning method, liquefied polymer is drawn into dispensing electrode 440, and then, subjected to the first electric field, charged and dispensed in a direction of mandrel 420. Moving with high velocity in the inter-electrode space, jet of liquefied polymer cools or solvent therein evaporates, thus forming fibers which are collected on the surface of mandrel 420.

Reference is now made to FIG. 18, which depicts an electrospinning apparatus used according to another preferred embodiment of the present invention in the manufacturing of the stent assembly. This apparatus is particularly useful for providing the second electric field as further detailed above. Thus, according to the presently preferred embodiment of the invention the second electric field is defined by a subsidiary electrode 460 which is kept at a second potential difference relative to mandrel 420.

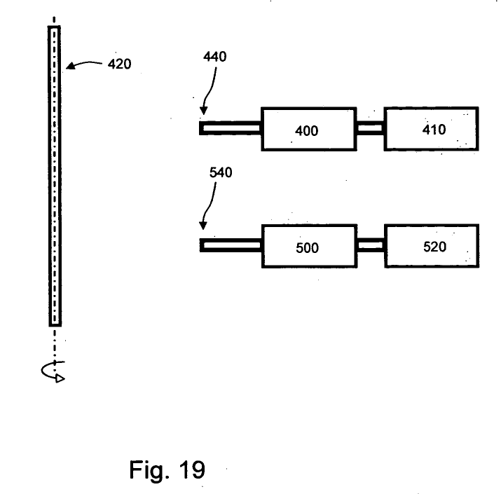

Reference is now made to FIG. 19, which depicts an electrospinning apparatus used according to another preferred embodiment of the present invention in the manufacturing of the stent assembly. In a presently preferred embodiment of the invention, the pharmaceutical agent is mixed with the liquefied polymer in bath 520 prior to the step of electrospinning. Then, the obtained compound is supplied by a pump 500 to an electrostatic sprayer 540 to be sprayed onto tubular supporting element 100 (not shown in FIG. 19) which is mounted on mandrel 420. Preferably, axially oriented fibers, which do not essentially contribute to the radial strength properties, can be made of biodegradable polymer and be drug-loaded. Such incorporation of the pharmaceutical agent results in slow release of the agent upon biodegradation of the fibers. The mixing of the pharmaceutical agent in the liquefied polymer may be done using any suitable method, for example by dissolving or suspending. The pharmaceutical agent may be constituted by particles or it may be in a dissolved form.

In the preferred embodiments in which the pharmaceutical agent is to be entrapped in the interstices of the non-woven web at the coat, the agent is preferably in a powder form or micro-encapsulated particulates form so that it can be sprayed as a shower of particles onto a specific layer of the coat, once formed.

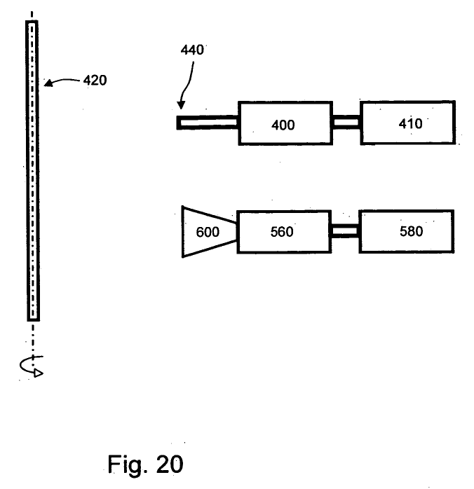

Reference is now made to FIG. 20 which depicts electrospinning apparatus used according to a presently preferred embodiment of the present invention. A biocompatible pharmaceutical agent drawn from a supply 580 is fed to electrostatic sprayer 560, whose output is sprayed through a conical deflector 600 to yield a spray of pharmaceutical particles which are directed toward the stent assembly. Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

A polycarbonate resin grade Caliper, 2071 was purchased from Daw Chemical Co. This Polymer is characterized as having good fiber forming abilities and is convenient for electrospinning. Chloroform was used as solvent in examples 1-4 cited hereinbelow.

### Axial Covering Using Conventional Electrospinning Method

Reference is now made to FIG. 21, which is an example of non-randomized covering of thin mandrels via conventional electrospinning. A 3-mm cylindrical mandrel was covered by polycarbonate fiber using prior art electrospinning approaches. FIG. 21 is an electron microscope image of the final product, in which axial fiber orientation is well evident. Due to non-uniformities in the electric field, the fibers, while still in motion in the inter-electrode space, are oriented in conformity with the field configuration, and the obtained tubular structure exhibits axial orientation of fibers, and as such is characterized by axial, as opposed to radial strength.

### Example 2

### Random Covering Using Flat Subsidiary Electrode

An apparatus constructed and operative in accordance with the teachings of the present invention incorporating a flat subsidiary electrode positioned 20 millimeters from the mandrel and having the same potential as the mandrel was used to spin a polycarbonate tubular structure of a 3 mm radius. As is evident from FIG. 22, the presence of a subsidiary electrode randomizes fibers orientation.

### Example 3

### Polar-Oriented Covering Using Flat Subsidiary Electrode

An apparatus constructed and operative in accordance with the teachings of the present invention incorporating a flat, subsidiary electrode positioned 9 millimeters from the mandrel and being at a potential difference of 5 kV from the mandrel was used to spin a polycarbonate tubular structure of a 3 mm radius.

As illustrated by FIG. 23, reduction of equalizing electrode-mandrel distance results in polar-oriented covering. Thus, by keeping subsidiary electrode and mandrel within a relatively small distance, while providing a non-zero, potential difference therebetween, leads to slow or no fiber charge dissipation and, as a result, the inter-electrode space becomes populated with fiber which are held statically in a stretched position, oriented perpendicular to mandrel symmetry axis. Once stretched, the fibers are gradually coiled around the rotating mandrel, generating a polar-oriented structure.

### Example 4

### Predefined Oriented Covering Using Linear Subsidiary Electrode

FIG. 24 illustrates result obtained from an apparatus configuration which may be employed in order to obtain a predefined oriented structural fiber covering.

An apparatus which includes an elliptical subsidiary electrode and a dispenser both moving along the longitudinal axis of the mandrel in a reciprocating synchronous movement was used to coat a 3-mm cylindrical mandrel with polycarbonate fiber. The subsidiary electrode had a large diameter of 120 mm, a small diameter of 117.6 mm and a thickness of 1.2 mm. The subsidiary electrode was positioned 15 mm from the mandrel, at an 80° tilt with respect to the mandrel symmetry axis.

### Coating of Rotary Stent

Examples 14-21, below relate to coating of rotary stent, according to the teachings various exemplary embodiments of the present invention.

### Example 5

A Carbothane PC-3575A was purchased from Thermedics Polymer Products, and was used for coating. This polymer has satisfactory fiber-generation abilities, it is biocompatibility and is capable of lipophilic drug incorporation. A mixture of dimethylformamide and toluene of ratio ranging from 1:1 to 1:2 was used as a solvent in all experiments.

A PHD 2000 syringe pump was purchased from Harvard Apparatus and was used in the electrospinning apparatus. A spinneret, 0.9 mm in inner diameter, was used as the dispensing electrode. The flow-rate of the spinneret was between 0.05 ml/min and 5 ml/min. The dispensing electrode was grounded while the mandrel was kept at a potential of about 20-50 kV. The mandrel, made of polished stainless steel, was rotated at frequency of 100-150 rotations per minute.

The dispensing electrode was positioned about 25 cm to 35 cm from the precipitation electrode and was connected to the pump—with flexible polytetrafluorethylene tubes. Reciprocal motion of the dispensing electrode, 30-40 mm in amplitude, was enabled along the mandrel longitudinal axis at a frequency of 2-3 motions/min.

A stent assembly, 16 mm in length was manufactured using a stainless-steel stent, 3 mm in diameter in its expanded state, 1.9 mm in diameter in its non-expanded state, as the tubular supporting element. The used stainless-steel stent is typically intended for catheter and balloon angioplasty. For adhesion upgrading in polymer coating, the stent was exposed to 160-180 kJ/m² corona discharge, rinsed by ethyl alcohol and deionized water, and dried in a nitrogen flow. The concentration of the solution was 8%; the viscosity was 560 cP; and the conductivity 0.8 μS. For the pharmaceutical agent, heparin in tetrahydroflirane solution was used, at a concentration of 250 U/ml. The polymer to heparin-solution ratio was 100:1. A metal rod, 1.8 mm in diameter and 100 mm in length was used as a mandrel.

To ensure uniform, high-quality coating of an electrode having a low-curvature radius, a planar subsidiary electrode was positioned near the mandrel, at a 40 mm distance from the longitudinal axis of the mandrel. The subsidiary electrode potential and the mandrel potential were substantially equal.

A two step coating process was employed. First, the mandrel was coated by electrospinning with polymer fiber layer the thickness of which was about 40 mm. Once the first step was accomplished, the tubular supporting element was put over the first coat hence an inner coating for the tubular supporting element was obtained. Secondly, an outer coating was applied to the outer surface of the tubular supporting element. The thickness of the outer coat was about 100 μm.

The stent assembly was removed from the mandrel, and was placed for about 30 seconds into the saturated DMF vapor atmosphere at 45° C., so as to ensure upgrading the adhesion strength between the inner coat and the-outer coat. Finally, to remove solvent remnants, the stent was exposed to partial vacuum processing for about 24 hours.

### Examle 6

A stent assembly was manufactured as described in Example 5, however the pharmaceutical agent was a heparin solution at a concentration of 380 U/ml mixed with 15% poly (DL-Lactide-CD-Glycolide) solution in chloroform.

In addition, for the dispensing electrode, two simultaneously operating spinnerets were used, mounted one above the other with a-height difference of 20 mm therebetween. The first operable to dispense polyurethane while the second operable to dispense the biodegradable polymer poly (L-lactic acid). To ensure desirable correlation between the fiber volumes of polyurethane and the biodegradable polymer, the solution feeding were 0.1 ml/min for the first spinneret and 0.03 ml/min for the second spinneret.

### Example 7

A stent assembly was manufactured from the materials described in Example 5.

A two step coating process was employed. First, the mandrel was coated by electrospinning with polymer fiber layer the thickness of which was about 60 μm. Once the first step was accomplished, the tubular supporting element was put over the first coat, hence an inner coating for the tubular supporting element was obtained. Before providing the outer coat, a subsidiary electrode, manufactured as a ring 120 mm in diameter, was mounted 16 mm behind the mandrel.

The subsidiary electrode was made of a wire 1 mm in thickness. The plane engaged by the subsidiary electrode was perpendicular to the mandrels longitudinal axis. As in Example 5, the subsidiary electrode potential and the mandrel potential were substantially equal, however, unlike Example 5, the subsidiary electrode was kinematically connected to the spinneret, so as to allow synchronized motion of the two.

The second coat was applied as in Example 5, until an overall thickness of 100 μm for the coatings was achieved.

Tests have shown that the fibers of biodegradable heparin-loaded polymer have predominant orientation, coinciding with the mandrel longitudinal axis, whereas the polyurethane fibers have predominant transverse (polar) orientation.

### Example 8

A stent assembly was manufactured as described in Example 5, with an aspirin powder added to the polymer solution. The particle root-mean-square (RMS) diameter was 0.2 μm. The powder mass content in the solution in terms of dry polymer amounted to 3.2%. For obtaining stable suspension, the composition was mixed for 6 hours using a magnetic stirrer purchased from Freed electric with periodic (1:60) exposure to a 32 Khz ultrasound obtained using a PUC40 device.

### Example 9

A stent assembly was manufactured as described under Example 7, yet the viscosity of the solution employed was higher (770 cP), so was its conductivity (2 μS). A solution having these characteristics promotes the production of coarser fibers and a flimsier fabric.

In addition, an aspirin powder was conveyed to a fluidized bed and fed to the spinneret. Sputtering and electrospinning were simultaneous but in an interrupted mode: 5 second sputtering followed by a 60 seconds break. The potential difference between the dispensing electrode and the mandrel was 23 kV, the interelectrode separation was 15 cm, and powder feeding rate was 100 mg/min.

### Example 10

A stent assembly having an outer coat and an inner coat was manufactured as described herein. The outer coat was made of a polymer solution having the parameters specified in Example 8, only a heparin solution was added thereto, as described in Example 7. The stent inner coating was made of polymer solution with the parameters specified in Example 5, only a heparin solution was added thereto, as described in Example 7. Thus, the inner coating was characterized by thin fibers and pore size of about 1 μm. A coating of this character ensures efficient surface endothelization. The outer surface had pores size of about 5-15 μm to ensure the ingrowth of tissues.

### Example 11

A stent assembly was manufactured as described in Example 5, except that for. both inner coat and outer coat a 6% ratamycine solution in chloroform was used. instead of heparin.

### Example 12

A stent assembly was manufactured as described in Example 5, except that a ticlopidine solution in chloroform was used instead of a heparin solution for the outer coat, whereas the inner coat was manufactured as in Example 5.

### Example 13

A stent assembly was manufactured from the materials described in Example 5, however, before coating by electrospinning the stent was first dipped into a TECOFLEX Adhesive 1-MP solution. In addition, the distance between the mandrel and subsidiary electrode was reduced to 20 mm. Still in addition, the step of post-treatment in solvent vapor was omitted.

The purpose of the present example was to generate an outer coat which exposes the gaps between the metal wires and exclusively covers metal wires of tubular supporting element. Hence, the mandrel was made of a dielectric material, whereas the tubular supporting element was kept under a potential of 25 kV, via electrical contacts.

### Coating of Non-Rotary Stent

Examples 22-26, below relate to coating of rotary stent, according to the teachings various exemplary embodiments of the present invention.

### Example 14

### Coating of Non-Rotary Stent

A Carbothane PC-3575A was purchased from Thermedics Polymer Products, and was used for coating. This polymer has satisfactory fiber-forming abilities, it is biocompatible and is capable of lipophilic drug incorporation. A mixture of dimethylformamide and toluene of ratio ranging from 1:1 to 1:2 was used as a solvent in all experiments.

A PHD 2000 syringe pump was purchased from Harvard Apparatus and was used for feeding the polymer solutions into the in the electrospinning apparatus. The dispensing element included a hollow ring, 400 mm in diameter, made of stainless tube. Three capillaries, 25 mm in length and 0.5 mm in internal diameter, were symmetrically disposed the internal surface of a ring. The flow-rate at each capillary was between 1 ml/min and 5 ml/min. The dispensing element was connected to the pump with flexible polytetrafluorethylene tubes and was grounded. A rod of polished stainless steel, 1.05 mm in diameter and 60 mm in length, was used as a mandrel and was kept at a potential of 30 kV. The mandrel was positioned in the geometrical center of the ring, about 175 mm from the capillaries ends.

The ring was rotated at a frequency of 60-1000 rpm and the mandrel was actuated to a longitudinal reciprocation motion, 30-40 mm in amplitude and 12-15 motions/min in frequency.

A stent assembly, 16 mm in length was manufactured using a stainless-steel stent, 3.4 mm in diameter in its expanded state and 1.1 mm in diameter in its non-expanded state, as the tubular supporting element. The used stainless-steel stent is typically intended for catheter and balloon angioplasty. For adhesion upgrading in polymer coating, the stent was exposed to 160-180 kJ/m² corona discharge, rinsed by ethyl alcohol and deionized water, and dried in a nitrogen flow. The solution parameters were: concentration of 8%, viscosity of 560 cP and conductivity of 0.8 mS. For the pharma-ceutical agent, heparin in tetrahydrofurane solution was used, at a concentration of 250 U/ml. The polymer to heparin-solution ratio was 100:1. The dispensing element rotating frequency was 60 rpm.

A two step coating process was employed. First, the mandrel was coated by electrospinning with polymer fiber layer the thickness of which was about 20 μm. Once the first step was accomplished, the tubular supporting element was put over the first coat hence an inner coating for the tubular supporting element was obtained. Second, an outer coating was applied to the outer surface of the tubular supporting element. The thickness of the outer coat was about 40 μm.

The stent assembly was removed from the mandrel, and was placed for about 30 seconds into the saturated dimethylformamide (DMF) vapor atmosphere at 45° C., so as to ensure upgrading the adhesion strength between the inner coat and the outer coat. To remove solvent remnants, the stent was exposed to partial vacuum processing for about 24 hours. Once the coating process was completed, the coated stent was subjected to elasticity tests by radial inflation.

The fibers of the resultant coat had a random-orientation. The coat was capable of bearing a 320% radial expansion without being ruptured. Example 15

A stent assembly was manufactured as described in Example 14, with an increased rotation frequency of 600 rpm. About 80% of the fibers of the resultant coat had an azimuthal orientation. The coat was capable of bearing a 410% radial expansion without being ruptured.

### Example 16

A stent assembly was manufactured as described in Example 14, with an increased rotation frequency of 1000 rpm. The resultant coat was more uniform and the fibers were mostly azimuthally oriented: about 95% of the fibers had an azimuthal orientation, and the coat was capable of bearing a 550% radial expansion without being ruptured.

### Example 17

A stent assembly was manufactured as described in Example 15, with a heparin solution at a concentration of 380 U/ml mixed with 15% poly (DL-Lactide CD-Glycolide) solution in chloroform. The change in the pharmaceutical agent did not affect the quality of the coat.

### Example 18

A stent assembly was manufactured from the materials described in Example 14, with 60 μm inner coat of biodegradable heparin-loaded polymer, and an outer coat of polyurethane fibers completing an overall coat thickness of 100 μm. The rotation frequencies of 60 rpm and 1000 rpm were used for providing the inner and outer coats, respectively. The resulting inner coat had a predominant axial (longitudinal) orientation, whereas the outer coat had a predominant azimuthal orientation, thus verifying that fiber orientation can be controlled by the dispensing element rotation frequency.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of coating a non-rotary object with an electrospun coat, the method comprising, dispensing a charged liquefied polymer through at least one dispensing element within an electric field to thereby form a jet of polymer fibers, and moving said dispensing element relative to said object so as to coat the object with the electrospun coat.

2. The method of claim 1, further comprising moving said electric field synchronically with said motion of said at least one dispensing element.

3. The method of claim 1, wherein said motion of said at least one dispensing element is selected so as to establish a spiral motion of said jet of said polymer fibers about the object, said spiral motion being characterized by a gradually deceasing radius.

4. The method of claim 1, further comprising translationally moving the object relative to said jet of said polymer fibers so as to uniformly distribute said polymer fibers onto the object.

5. The method of claim 1, wherein a medicament is mixed with said charged liquefied polymer and is co-dispensed therewith through said at least one dispensing element, so as to coat the object with an electrospun medicated coat.

6. An apparatus for coating a non-rotary object with an electrospun coat, the apparatus comprising at least one dispensing element being at a potential difference relative to the object, said at least one dispensing element being capable of moving relative to said object while dispensing a charged liquefied polymer within an electric field defined by said potential difference, to thereby form a jet of polymer fibers coating the object.

7. The apparatus of claim 6, wherein said at least one dispensing element is designed and constructed such that said electric field moves synchronically with said motion of said at least one dispensing element.

8. The apparatus of claim 6, wherein said motion of said at least one dispensing element is selected so as to establish a spiral motion of said jet of said polymer fibers about the object, said spiral motion being characterized by a gradually deceasing radius.

9. The apparatus of claim 6, wherein said at least one dispensing element comprises a rotatable ring having at least one capillary.

10. The apparatus of claim 9, wherein said rotatable ring is made of a dielectric material.

11. The apparatus of claim 9, wherein said rotatable ring is made of a conductive material.

12. The apparatus of claim 6, further comprising a mechanism for translationally moving the object relative to said jet of said polymer fibers so as to uniformly distribute said polymer fibers onto the object.

13. The apparatus of claim 6, further comprising a sprayer for distributing compact objects constituting a mendicant therein between said polymer fibers.

14. A method of treating a constricted blood vessel, the method comprising:
(a) providing a stent assembly;
(b) dispensing a charged liquefied polymer through at least one dispensing element within an electric field to thereby form a jet of polymer fibers, and moving said dispensing element relative to said stent assembly so as to coat said stent assembly with an electrospun coat; and
(c) placing said stent assembly in the constricted blood vessel.

15. The method of claim 14, further comprising expanding said stent assembly so as to dilate tissues surrounding said stent assembly in a manner such that flow constriction is substantially eradicated.

16. The method of claim 14, further comprising moving said electric field synchronically with said motion of said at least one dispensing element.

17. The method of claim 14, wherein said motion of said at least one dispensing element is selected so as to establish a spiral motion of said jet of said polymer fibers about said stent assembly, said spiral motion being characterized by a gradually deceasing radius.

18. The method of claim 14, further comprising translationally moving said stent assembly relative to said jet of said polymer fibers so as to uniformly distribute said polymer fibers onto said stent assembly.

19. The method of claim 14, wherein said stent assembly is mounted on a stent delivery system.

20. The method of claim 14, wherein a medicament is mixed with said charged liquefied polymer and is co-dispensed therewith through said at least one dispensing element, so as to coat the object with an electrospun medicated coat.
